(19) United States
(12) Patent Application Publication
(10) Pub. No.: US 2026/0363948 A1
(43) Pub. Date: Nov. 19, 2026

(54) APPARATUS WITH DESIGN PATTERN TO MITIGATE PATHOLOGICAL RESPONSE OF BODY

(71) Applicant: Arthur Flick, Lakemont, GA (US)

(72) Inventor: Arthur Flick, Lakemont, GA (US)

(21) Appl. No.: 19/674,789

(22) Filed: May 12, 2026

Related U.S. Application Data
(60) Provisional application No. 63/805,490, filed on May 14, 2025.

(51) Int. Cl. A61H 99/00

(52) U.S. Cl. CPC A61H 99/00; A61H 2201/165

(57) ABSTRACT

An apparatus to mitigate a pathological response of an affected area of a body is disclosed. The apparatus may include a substrate and a predefined pattern disposed on the substrate. The substrate is configured for placement on or in proximity to the body. The predefined design pattern may include a plurality of continuous curvilinear structures extending from a central portion of the substrate toward an outer boundary of the substrate. The plurality of continuous curvilinear structures is arranged in a radial configuration about the central portion. Each of the plurality of continuous curvilinear structures defines a continuous, non-planar surface having a curvature that is spatially related to adjacent ones of the plurality of continuous curvilinear structures.

### CROSS-REFERENCE TO RELATED APPLICATION

The present application claims the benefit of U.S. Provisional Patent Application No. 63/805,490, filed on May 14, 2025, the entire disclosure of which is hereby incorporated by reference herein.

### TECHNICAL FIELD

The present disclosure relates to an apparatus with a predefined design pattern configured for placement on or near biological tissue, and more particularly to an apparatus having three-dimensional and two-dimensional design patterns which, when placed on or in close proximity to the skin of humans or animals, are associated with reductions in symptoms of inflammation, including pain.

### BACKGROUND

Inflammation can affect human and animal bodies in both positive and negative ways. Inflammation is a natural response to injury or infection that helps the body heal. Inflammation can be triggered by tissue damage, viruses and bacteria. Acute inflammation is the body's protective response to an injury or infection. For example, when a hand is cut or injured, white blood cells are sent to protect the area. The body may experience swelling, redness, and pain, but this process is critical to fighting an infection. Chronic inflammation may occur when the body tries to rid itself of harmful substances such as an infectious organism, an irritant, or a chemical toxin. Increased levels of chronic inflammation are also associated with an unhealthy lifestyle, including a poor diet, alcohol consumption, sedentary behavior, stress, and weight gain. Most autoimmune diseases, including type 1 diabetes, rheumatoid arthritis, lupus, psoriasis, inflammatory bowel disease, and multiple sclerosis, also cause chronic inflammation.

Treating inflammation can involve a range of approaches depending on its cause (acute versus chronic) and severity. Medications may include non-steroidal anti-inflammatory drugs such as ibuprofen, naproxen and aspirin. In addition, medications may include corticoseriods such as prednisone and methylprednisolone. Additional measures such as dietary interventions, physical therapy, acupuncture, Transcutaneous Electrical Nerve Stimulation (TENS), magneto therapy, laser phototherapy, and/or the like may also be implemented to treat inflammation. Such treatment methods are the subject of ongoing research and clinical trials. While efficacy of such treatments are now well known, improvements are required to further enhance their efficiency. In addition, ongoing research may reveal new treatment modalities.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts an example first apparatus to mitigate a pathological response of an affected area of a body in accordance with the present disclosure.

FIG. 2 depicts an example second apparatus to mitigate a pathological response of an affected area of a body in accordance with the present disclosure.

FIG. 3 depicts an example third apparatus to mitigate a pathological response of an affected area of a body in accordance with the present disclosure.

FIG. 4 depicts an example of a fourth apparatus to mitigate a pathological response of an affected area of a body in accordance with the present disclosure.

FIG. 5 depicts an example fifth apparatus to mitigate a pathological response of an affected area of a body in accordance with the present disclosure.

FIG. 6 depicts an example sixth apparatus to mitigate a pathological response of an affected area of a body in accordance with the present disclosure.

FIG. 7 depicts an example seventh apparatus to mitigate a pathological response of an affected area of a body in accordance with the present disclosure.

FIG. 8 depicts a negative relief pattern, positive-relief patterns, and a hologram pattern on an apparatus substrate to mitigate a pathological response of an affected area of a body in accordance with the present disclosure.

FIG. 9 depicts an example of a plurality of apparatuses axially aligned and adhered together to mitigate a pathological response.

FIG. 10 depicts an example of an elbow brace comprised of apparatuses to mitigate a pathological response of an affected area of a body in accordance with the present disclosure.

FIG. 11 depicts an example of a geometric array of apparatuses to mitigate a pathological response of an affected area of a body in accordance with the present disclosure

FIG. 12 depicts an example wound dressing in accordance with the present disclosure.

FIG. 13 depicts an example pattern of apparatus incorporated in a wrist band to mitigate a pathological response of an affected area of a body in accordance with the present disclosure.

FIG. 14 depicts an example of a plurality of apparatuses on a belt to mitigate a pathological response

FIG. 15 depicts a foot orthotic to mitigate a pathological response of an affected area of a body in accordance with the present disclosure

FIG. 16 depicts an example of an ankle brace apparatus to mitigate a pathological response of an affected area of a body in accordance with the present disclosure.

FIG. 17 depicts an example of a plurality of apparatuses positioned within a bra cup to mitigate a pathological response of an affected area of a body in accordance with the present disclosure.

FIG. 18 depicts an example of apparatus in contact with an ear lobe to mitigate a pathological response of an affected area of a body in accordance with the present disclosure.

FIG. 19 depicts an example of apparatus incorporated in a knee brace to mitigate a pathological response of an affected area of a body in accordance with the present disclosure.

FIG. 20 depicts an example of apparatus incorporated in knee-high compressive stockings to mitigate a pathological response of an affected area of a body in accordance with the present disclosure.

FIG. 21 depicts an example of apparatus incorporated in a neck brace and clothing apparel to mitigate a pathological response of an affected area of a body in accordance with the present disclosure.

FIG. 22 depicts an example of clothing apparel to mitigate a pathological response of an affected area of a body in accordance with the present disclosure.

FIG. 23 depicts an example of a plurality of apparatuses positioned within a hat/cap to mitigate a pathological response of an affected area of a body in accordance with the present disclosure.

FIG. 24 depicts an example of a plurality of apparatuses positioned on the forearm during IV therapy in accordance with the present disclosure.

FIG. 25 depicts an example of an enclosure in accordance with the present disclosure.

FIGS. 26A, 26B, 26C depict example tables and graphs illustrating patient responses in accordance with the present disclosure.

FIG. 27 depicts an example of a crossover study in accordance with the present disclosure.

### DETAILED DESCRIPTION

### Overview

The present disclosure describes an apparatus that facilitates in mitigating or reducing pathological response of an affected area of a human or animal body. The apparatus may include a substrate and a predefined pattern formed on the substrate. The apparatus may be placed on or in close proximity to the body's affected area (e.g., an area that may be infected, damaged, cut, and/or the like, or an area that may be having chronic inflammation) to mitigate the area's pathological response. For example, if the user is experiencing pain or redness, the user may place the apparatus on or in close proximity to the affected area, and the apparatus then facilitates in reducing the pain, redness, etc. Specifically, the pattern formed on the substrate is a specialized design that is clinically tested to mitigate the pathological response of the affected area, when the pattern is disposed in proximity to the affected area.

The pattern described above includes novel two-dimensional and three-dimensional designs (or “spin field designs”) which, when placed on or in close proximity to the skin of humans and animals, interact with the biosystem's response to pathological processes. The biosystem's clinical response to the application of predefined design pattern (spin field design) was unexpected and not obvious. Applying the spin field designs in close proximity to or touching human or animal skin adjacent to an area of pathological dysfunction demonstrated clinical reduction of the cardinal signs of inflammation (pain, swelling, redness, and heat). The reduction in the inflammatory response was unexpected, new, and unobvious.

In an exemplary aspect, the pattern or the spin field designs may include a plurality of curvilinear structures that originates from a center portion of the substrate and terminates in a circular configuration at an outer edge of the substrate. The curvilinear structures may be algebraic curves defined by polynomial equations of x and y or transcendental curves defined by non-algebraic functions such as trigonometric or exponential functions.

In further aspects, the curvilinear structures on the substrate may be grouped in a plurality of sets, where each set may include a predefined count of curvilinear structures (which may be greater than 1). In the exemplary aspect, a count of sets may be 12 and the count of curvilinear structures in each set may be 6. Such a structure/arrangement/design of the pattern has shown considerable positive response from patients in clinical testing. In another aspect, the count of sets may be 6, and each set may have either 3, 6 or 9 curvilinear structures. Further, the curvilinear structures may be rotated in clockwise or counterclockwise directions.

In accordance with further aspects/embodiments, the present disclosure describes the clinical application of two-dimensional and three-dimensional spin field designs on a plurality of substrates, shapes, geometries, application methods and single or collimated spin field discs/ substrates including, but not limited to, kinesthetic sports tape, wound dressings, food and beverage labels, enclosures for electronic devices, tuning forks, orthotics, braces and splints.

In further aspects, the apparatus disclosed in the present disclosure may modulate the radiation from pulsed coherent light fields and pulsed magnetic fields disclosed in U.S. patent application Ser. Nos. 18/496,374 and 18/496,370 (both filed on Oct. 27, 2023), the applications of which are incorporated by reference herein in their entireties. The U.S. patent application Ser. Nos. 18/496,374 and 18/496,370 disclose light sources that may emit pulses of coherent light modulated at a plurality of low frequencies based on command signals obtained from a frequency generator.

In further aspects, the disclosed apparatus may be combined with a phototherapy light emitting device with or without a fluid vessel and a magnetic field generating device to perform enhanced phototherapy (such devices are disclosed in U.S. patent application Ser. Nos. 18/496,374 and 18/496,370). The synchronized pulses of coherent light beams emitted at the plurality of low frequencies (ranging from 0.1 Hz to 5,000 Hz), disclosed in the U.S. patent application Ser. Nos. 18/496,374 and 18/496,370, passing through the apparatus results in enhanced phototherapy.

In addition, the disclosed apparatus may be combined with pulsed magnetic fields emitting inductor coils (the apparatus may be placed on the surface of the magnetic field-generating enclosure or on magnetic inductor coils) to enhance the magneto therapy effect.

In certain embodiments, the apparatus may operate without externally applied electrical stimulation. Further, the apparatus may be configured for direct skin contact. Further, the predefined geometric pattern on the apparatus is configured to modulate transepithelial potential. Furthermore, the predefined geometric pattern is configured to modulate red blood cell zeta potential. The predefined geometric pattern is further configured to interact with a local bioelectrical environment of tissue. Further, the predefined geometric pattern provides a distributed geometric interaction with biological tissue rather than discrete point stimulation.

The disclosed apparatus is associated with reduction of at least one of the cardinal signs of inflammation: pain, swelling, heat and erythema.

The present disclosure further discloses a method for modulating a physiological response in a subject. The method includes positioning the apparatus described above (and in detail later below) adjacent to or in contact with a target anatomical region of the subject. Placement or positioning of the apparatus adjacent to the target anatomical region produces a change in at least one electrophysiological parameter associated with inflamed tissue. The electrophysiological parameter includes transepithelial potential, and/or red blood cell zeta potential.

The present disclosure further discloses a physiological modulation system including at least one wearable support structure configured to be worn on a body of a user, and a plurality of apparatus elements coupled to the wearable support structure. Each apparatus element is similar to the apparatus described above.

The present disclosure further discloses a surface structure configured for interaction with biological tissue. The surface structure comprises a plurality of continuous non-intersecting curvilinear structures arranged in a radial configuration extending from a central region toward an outer region. The curvilinear structures are organized into a plurality of sets, and spacing between adjacent sets differs from spacing between adjacent curvilinear structures within a set. Further, the arrangement defines a distributed non-planar geometric interface configured to influence electrophysiological conditions associated with inflamed tissue.

The present disclosure further discloses method of manufacturing a physiological modulation apparatus. The method comprises forming a predefined pattern on a substrate, where the predefined pattern comprises a plurality of continuous curvilinear structures extending from a central region toward an outer region. The predefined pattern is formed by etching, molding, embossing, additive manufacturing or holographic pattern formation.

These and other advantages of the present disclosure are provided in detail herein.

### Illustrative Embodiments

The disclosure will be described more fully hereinafter with reference to the accompanying drawings, in which example embodiments of the disclosure are shown, and not intended to be limiting.

Inflammation is a physiological response that occurs in human and animal tissues following injury, infection, or exposure to harmful stimuli. While acute inflammation can promote healing, chronic inflammation is associated with a wide range of pathological conditions, including autoimmune disorders, musculoskeletal conditions, and localized tissue damage. Conventional treatments include pharmacological agents such as non-steroidal anti-inflammatory drugs (NSAIDs) and corticosteroids, as well as non-pharmacological therapies including physical therapy, acupuncture, transcutaneous electrical nerve stimulation (TENS), magnetic therapy, and phototherapy. Although such approaches may provide symptomatic relief, they may be associated with side effects, limited efficacy, or the need for repeated intervention.

Accordingly, various passive devices have been proposed for application to the skin or in proximity to the body. Such devices include adhesive patches, tapes, discs, and wearable articles that may incorporate surface textures, raised features, embedded materials, or decorative patterns. For example, certain devices employ embossed or textured surfaces intended to provide mechanical stimulation to the skin, while others utilize magnets, conductive elements, or claimed energy-modulating materials. Still other devices incorporate holographic or optically patterned films that are purported to influence physiological responses.

Surface patterning techniques are also widely known in non-medical contexts. For example, molded, etched, or embossed substrates having repeating geometric features—such as ridges, grooves, concentric rings, or radial patterns—are commonly used in decorative materials, optical films, and functional surfaces. Holographic structures capable of producing three-dimensional visual effects through diffraction and light scattering are also well known and are used in a variety of applications, including packaging, security labeling, and consumer products.

Despite the existence of such patterned surfaces and passive devices, these conventional approaches generally employ arbitrary, decorative, or functionally unrelated geometries. Known devices do not disclose or suggest a predefined design pattern comprising a plurality of continuous, non-intersecting curvilinear structures arranged in a specific radial configuration extending from a central portion of a substrate toward an outer boundary, wherein each curvilinear structure defines a continuous, non-planar surface having a defined curvature and spatial relationship relative to adjacent structures.

Furthermore, existing devices fail to disclose or suggest organizing such curvilinear structures into discrete sets having defined spacing relationships, including configurations in which a first distance between adjacent sets differs from a second distance between adjacent structures within a set. Known patterned surfaces also fail to disclose configurations in which individual curvilinear structures correspond to portions of circles having dimensions related to the overall geometry of the substrate, or arrangements exhibiting controlled rotational symmetry, including combinations of clockwise and counterclockwise orientations.

Additionally, while certain prior devices incorporate surface textures or patterns, such devices do not teach or suggest the specific combination of three-dimensional relief structures (including positive-relief and negative-relief geometries) and/or two-dimensional holographic configurations arranged according to a predefined geometric relationship as described herein. Nor do such devices disclose the integration of these specific geometric configurations into flexible, biocompatible substrates configured for placement on or near an affected area of a body.

Accordingly, there remains a need for an improved apparatus that incorporates a specifically defined geometric design pattern, rather than arbitrary or decorative surface features, wherein the pattern's structural configuration is selected to interact with a body in a manner that mitigates pathological responses.

A number of prior art references disclose devices configured for application to the skin for therapeutic or physiological purposes. Such devices include acupressure patches, adhesive discs, transdermal delivery systems, and substrates having structured or textured surfaces. While these references demonstrate that it is known to apply devices to the body, they differ significantly in both structure and mode of operation from the presently claimed invention.

For example, U.S. Pat. No. 5,792,176 to Chang discloses an acupressure device comprising an adhesive patch having a rigid body and a protruding pressure element configured to apply localized pressure to a specific point on the skin. The therapeutic effect in Chang is achieved through mechanical stimulation of a discrete anatomical location via a raised nub or projection. Similarly, U.S. Pat. No. 6,261,306 to Kramer discloses an acupressure device including a plurality of protrusions or beads arranged on a substrate. The arrangement of these protrusions is based on acupressure or reflexology principles, such that individual protrusions correspond to anatomical treatment points. In both Chang and Kramer, the operative mechanism is the application of localized pressure at discrete points, rather than interaction with a continuous surface geometry. Neither Chang nor Kramer discloses continuous curvilinear structures. Chang discloses a single protruding nub and Kramer discloses discrete beads or protrusions. These references are limited to point-based elements, not continuous geometries.

Additional prior art, such as International Publication WO2001/064160, also discloses acupressure-type devices incorporating protruding elements and positioning structures to align the device with anatomical landmarks. These devices similarly rely on discrete mechanical stimulation. Other references, including U.S. Patent Application Publication 2015/0038892, disclose substrates having micro-scale surface structures such as ridges and grooves intended to influence cellular behavior. However, such structures are typically defined at micro-scale dimensions and are designed for localized cellular interaction, rather than macro-scale geometric interaction across a body surface. Further, US 2015/0038892 discloses linear ridges and grooves, not radial structures, curvilinear arcs and structures extending from a central point. The cited art does not teach or suggest radially organized continuous arcs.

Further, transdermal patch technologies, such as those disclosed in WO2022/248583, are directed to delivery of active agents through the skin. These devices rely on chemical or pharmacological mechanisms, rather than structural surface geometry, to achieve a therapeutic effect. Similarly, other patch-based devices may incorporate magnets, conductive materials, or embedded elements, but continue to rely on mechanisms external to the geometric configuration of the surface itself.

While certain prior art references may include patterned or textured surfaces, such patterns are generally decorative, arbitrary, or functionally unrelated to a defined geometric configuration. Known devices do not disclose or suggest a predefined pattern comprising a plurality of continuous curvilinear structures arranged in a radial configuration extending from a central portion of a substrate toward an outer boundary. Nor do such references disclose curvilinear structures that define portions of circles having dimensions related to the geometry of the substrate.

Importantly, the prior art fails to disclose or suggest organizing such curvilinear structures into discrete sets having defined spatial relationships. The presently claimed invention includes arrangements in which a first distance between adjacent sets differs from a second distance between adjacent structures within a set, thereby creating a hierarchical geometric organization. No cited reference teaches or suggests such multi-level spatial relationships within a patterned surface.

Additionally, the claimed invention provides curvilinear structures exhibiting controlled rotational symmetry, including embodiments incorporating clockwise-oriented structures, counterclockwise-oriented structures, or combinations thereof. In contrast, prior art devices employing multiple elements are typically arranged according to anatomical mapping or arbitrary placement, and do not exhibit controlled geometric symmetry of this nature.

The present invention further differs in that it utilizes a continuous, non-planar surface geometry distributed across the substrate, rather than discrete protrusions or localized features. In contrast to the point-based stimulation of Chang and Kramer, the claimed apparatus provides a distributed interaction with the body via a continuous pattern of curvilinear structures. This distinction represents a fundamental structural and functional difference from the prior art.

Moreover, the claimed apparatus is configured to interact with the body via its geometric surface structure without reliance on externally applied pressure, chemical delivery, magnetic fields, or electronic components. Prior art devices, by contrast, depend on such mechanisms to achieve therapeutic effects. The absence of such external mechanisms in the present invention further distinguishes it from known devices. In addition, the claimed apparatus operates with or without direct contact with the skin.

The present invention also operates at a macro-scale level, wherein the geometric pattern is visible and extends across a substantial portion of the substrate. This contrasts with micro-structured surfaces, such as those disclosed in U.S. Patent Application Publication 2015/0038892, which operate at micro-scale dimensions and are not configured as macro-scale geometric patterns having defined radial organization and symmetry.

Accordingly, the prior art fails to disclose or suggest the combination of features recited in the present claims, including (i) a plurality of continuous curvilinear structures arranged in a radial configuration, (ii) defined geometric relationships between the structures and the substrate, (iii) organization into sets with distinct spacing relationships, and (iv) controlled rotational symmetry. The differences between the claimed invention and the cited references are not merely matters of design choice but instead reflect a fundamentally different structural configuration and mode of interaction with the body.

Biological tissues exhibit intrinsic electrical properties arising from ionic transport across cellular membranes, and such electrophysiological characteristics are fundamental regulators of both physiological and pathological processes. Among these properties, the transepithelial potential (TEP) of epithelial tissues and the zeta potential of circulating red blood cells are measurable, functionally significant parameters that are directly altered during inflammatory states.

Inflammation disrupts electrophysiological homeostasis through well-characterized mechanisms. In epithelial tissues, inflammatory processes impair ion transport and barrier integrity, thereby reducing and dysregulating the transepithelial potential (TEP) relative to baseline, non-inflamed conditions. In the circulatory system, inflammatory mediators increase plasma protein concentrations, which reduce the negative surface charge of red blood cells, thereby decreasing zeta potential. This reduction in zeta potential directly causes increased erythrocyte aggregation, formation of rouleaux structures, and elevation of erythrocyte sedimentation rate (ESR), all of which are recognized markers of inflammation.

Accordingly, TEP and red blood cell zeta potential are not merely correlates of inflammation, but functional electrophysiological drivers and indicators of the inflammatory state. Restoration of these parameters toward baseline values is indicative of, and contributes to, resolution of the inflammatory process.

The present disclosure departs from conventional therapeutic approaches by recognizing that passive geometric structure, when placed on or in proximity to biological tissue, has been observed to be associated with changes in electrophysiological parameters under experimental and clinical conditions

In particular, the disclosed apparatus includes a predefined design pattern comprising a plurality of continuous, non-intersecting curvilinear structures arranged in a radial configuration. This geometry is configured to interact with biological tissue and the surrounding bioelectrical environment and is configured to interact with biological tissue via the distributed geometric interface, and has been observed to correspond with changes in local electrophysiological conditions, including charge distribution and electrical potential characteristics.

Experimental and clinical observations demonstrate that placement of the apparatus on or in proximity to inflamed tissue has been observed, in certain experimental and clinical evaluations, to be associated with measurable changes in electrophysiological parameters, including: (i) shifts in transepithelial potential (TEP) toward values observed in non-inflamed epithelial tissue; and (ii) changes in red blood cell zeta potential toward baseline negative surface charge values.

These effects are not observed in the absence of the predefined design pattern, nor are they reproduced by arbitrary, decorative, or alternative geometric configurations. Accordingly, the predefined design pattern is configured such that placement of the apparatus is associated with normalization trends in electrophysiological parameters under certain conditions

Without being limited to a single mechanistic pathway, the disclosed apparatus is configured such that interaction between the predefined geometric pattern and biological tissue produces normalization of electrophysiological conditions that are causally linked to inflammation. Because inflammatory processes are known to alter both TEP and zeta potential, and because restoration of these parameters reverses key aspects of inflammatory physiology, the apparatus is therefore configured to reduce inflammation by restoring electrical homeostasis within the tissue and circulatory system.

Stated differently, placement of the apparatus has been observed to correlate with modulation of TEP and red blood cell zeta potential in certain subjects. This establishes a functional and mechanistic linkage between the predefined geometric design and physiological outcome.

Importantly, the operative effect arises solely from the geometric configuration of the surface, without reliance on externally applied energy, pharmacological agents, mechanical pressure, or electronic components. The predefined design pattern therefore constitutes an active geometric interface configured to produce a physiological effect through modulation of electrophysiology.

This mechanism of action fundamentally distinguishes the present disclosure from prior art devices, which fail to recognize, disclose, or suggest that specific passive geometric configurations can be configured to restore transepithelial potential and red blood cell zeta potential, and thereby reduce inflammation.

In addition, clinical observations and pilot evaluations have indicated reductions in reported pain scores and inflammatory symptoms when the patterned substrate is placed adjacent to pathological processes. These reductions have been observed across multiple anatomical regions and inflammatory conditions.

Accordingly, the utility of the claimed system is grounded in reproducible, observable physiological changes, without requiring a fully defined or singular mechanism of action. The absence of a complete mechanistic explanation does not preclude operability or utility, particularly where measurable outcomes are consistently demonstrated.

For at least these reasons, the presently claimed invention is novel and non-obvious over the cited prior art.

The present disclosure relates to an apparatus including a substrate having a predefined geometric design pattern configured for placement on or in proximity to biological tissue. The apparatus is structured to provide a distributed geometric interface between the substrate and the body, in contrast to devices that rely on discrete point-based contact or externally applied energy sources. The disclosed apparatus is applicable to human and animal subjects and may be incorporated into a wide range of configurations, including patches, dressings, wearable articles, and support structures.

As used herein, the term “distributed geometric interface” refers to a continuous or semi-continuous interaction region formed by a plurality of spatially arranged surface features that collectively engage a body surface over an area, in contrast to discrete point-based or linear contact features. The term “curvilinear structure” refers to a continuous geometric feature having curvature along at least one axis and defining a non-linear path across a substrate. The term “non-planar surface” refers to a surface exhibiting variation in elevation or contour in at least one dimension such that the surface is not flat. The term “associated with,” when used in reference to physiological effects, denotes a correlation observed under experimental or clinical conditions and does not require direct causation by a single identified mechanism. The term “baseline value” refers to a value or range of values observed in non-pathological or less-inflamed biological tissue under comparable measurement conditions.

In one embodiment, an apparatus includes a substrate having a central region and an outer boundary. The substrate may be rigid, semi-rigid, or flexible, and may be formed from biocompatible materials including, but not limited to, polyethylene terephthalate (PET), polyimide, liquid crystal polymer (LCP), polytetrafluoroethylene (PTFE), or polylactic acid (PLA). A predefined design pattern is disposed on the substrate. The predefined design pattern comprises a plurality of continuous, non-intersecting curvilinear structures arranged in a radial configuration extending from the central region toward the outer boundary. Each curvilinear structure defines a continuous, non-planar surface having a predetermined curvature and spatial relationship relative to adjacent curvilinear structures. The curvilinear structures may be substantially identical in curvature and length in certain embodiments, or may vary in accordance with design requirements. Collectively, the plurality of curvilinear structures forms a distributed geometric interface across the substrate. This interface is characterized by continuous surface geometry extending across multiple structures and defined spatial relationships between adjacent structures.

In certain embodiments, the curvilinear structures are organized into a plurality of sets. Each set may include a predetermined number of curvilinear structures. A first spacing between adjacent sets may differ from a second spacing between adjacent structures within a set, thereby defining a hierarchical spatial organization. Regions between adjacent sets may be substantially free of curvilinear structures. The predefined design pattern may exhibit rotational symmetry. In various embodiments, the curvilinear structures may be oriented in a clockwise direction, a counterclockwise direction, or a combination thereof. In some implementations, each curvilinear structure corresponds to a portion of a circle, and may be defined such that, if extended, it forms a complete circle having dimensions related to the geometry of the substrate.

The predefined design pattern may be implemented using a variety of surface configurations, including: (i) three-dimensional negative-relief structures formed by material removal; (ii) three-dimensional positive-relief structures formed by additive processes; (iii) conductive structures disposed on the substrate; or (iv) substantially planar structures, including holographic or optically patterned surfaces. The selection of surface implementation may vary depending on the intended application and manufacturing process.

The apparatus may be positioned; (i) in direct contact with the skin; (ii) adjacent to the skin through an intervening material layer, or (iii) within a defined proximity to biological tissue. In certain embodiments, the apparatus is positioned within approximately 0 mm to 10 mm of the tissue surface, although other distances may be used. The apparatus may be incorporated into wearable systems including, but not limited to: adhesive patches, wound dressings, braces and orthotic devices and garments or compressive articles

Without being limited to a particular mechanism of action, placement of the apparatus on or in proximity to biological tissue has been observed, in certain experimental and clinical evaluations, to be associated with changes in physiological parameters. Such parameters may include electrophysiological characteristics of biological tissue and circulating components.

In particular, observed electrophysiological changes may include shifts in transepithelial potential (TEP) toward values observed in non-inflamed tissue. The transepithelial potential (TEP) of the epidermis may be measured using microelectrode-based sensing techniques adapted from continuous glucose monitoring devices wherein a small, biocompatible microelectrode is inserted into or positioned beneath the epidermal layer. Measuring the TEP requires a sensing electrode positioned within the epidermis or superficial dermis, while a reference electrode is placed on the skin surface. The electrodes are electrically coupled to a high-impedance measurement circuit configured to detect low-amplitude voltage differences on the order of millivolts. The TEP averages between minus 20 mV and minus 40 mV with the inside (basal side) negative relative to the surface.

In addition, observed electrophysiological changes may include changes in red blood cell zeta potential toward baseline surface charge values. The red blood cell negative surface charge is directly reflected in a change in the serum erythrocyte sedimentation rate (ESR). The normal baseline ranges for ESR in adult men is 0 to 15 mm/hour and in women 0 to 20 mm/hour. Mild inflammation is between 20 and 40 mm/hour, moderate inflammation 40 to 70 mm/hour and severe inflammation 70 to 100 mm/hour.

The disclosed apparatus is believed to interact with the body via its distributed geometric interface, which may correspond with changes in local conditions at or near the tissue interface. However, the invention is not limited to any specific theoretical explanation, and operability does not depend on the identification of a single mechanism. Measurements may be obtained prior to placement and after placement of the apparatus for a defined duration. Observed changes may include directional shifts toward baseline values and do not require attainment of a specific absolute value.

The magnitude of observed physiological changes may vary depending on: (i) anatomical location; (ii) degree of inflammation; (iii) duration of application; (iv) positioning of the apparatus. In some cases, measurable changes may not be observed in all subjects or conditions, and such variability does not negate operability of the apparatus.

Comparative evaluations of alternative surface patterns have indicated that not all geometric configurations produce equivalent results. Patterns lacking one or more of the following characteristics: (i) continuous curvilinear structures; (ii) radial organization; (iii) defined spacing relationships between structures have not exhibited the same level of observed physiological association under comparable conditions. Additionally, variations in rotational symmetry have been evaluated, and certain symmetry configurations have been observed to correspond with greater effectiveness relative to others.

In clinical and observational evaluations, placement of the apparatus adjacent to symptomatic tissue has been associated with reductions in reported symptoms, including pain, swelling, and redness. Such observations have been reported across multiple anatomical regions and conditions. These observations are provided to illustrate potential applications of the disclosed apparatus and are not intended to limit the scope of the invention.

The disclosed apparatus provides a structurally defined geometric interface that differs fundamentally from conventional devices relying on point-based pressure stimulation, pharmacological delivery, or externally applied energy. By employing a predefined arrangement of continuous curvilinear structures organized in a radial configuration, the apparatus establishes a distributed geometric interface that, in certain implementations, has been observed to be associated with measurable physiological changes. The invention is defined by the appended claims and encompasses variations in structure, materials, and configuration consistent with the principles described herein.

The present disclosure will be described more fully hereinafter with reference to the accompanying drawings, in which exemplary embodiments are shown. These embodiments are provided for illustrative purposes only and are not intended to limit the scope of the disclosure.

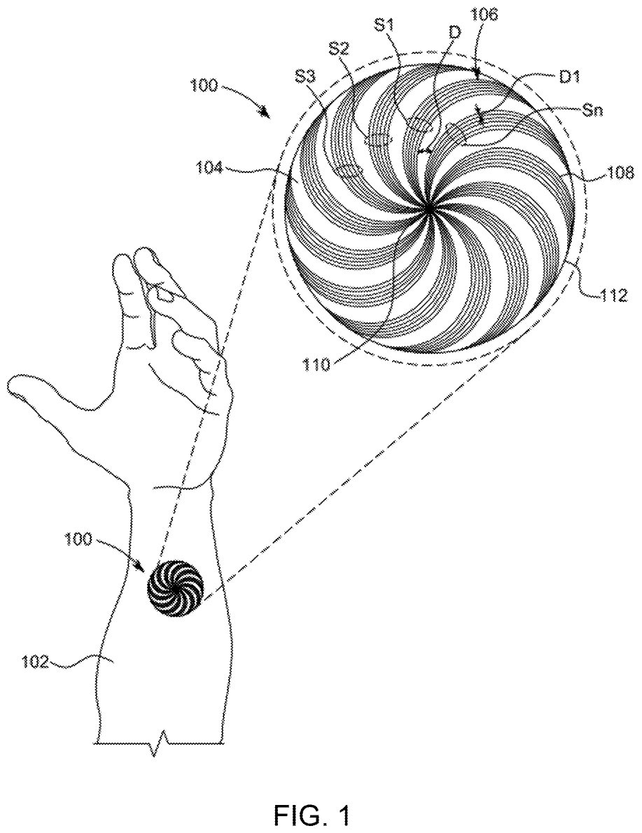

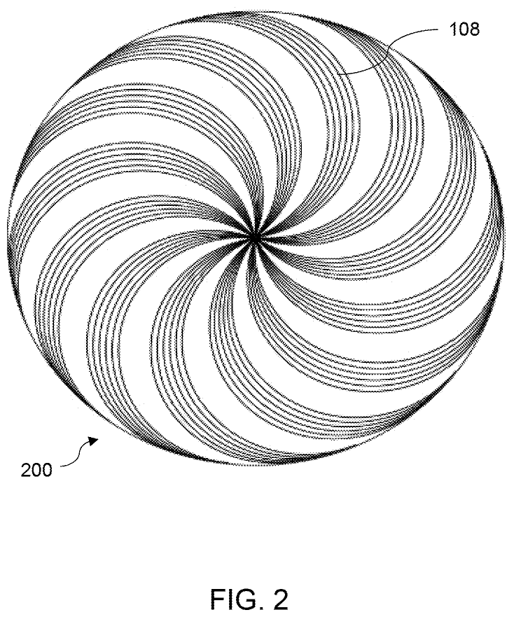

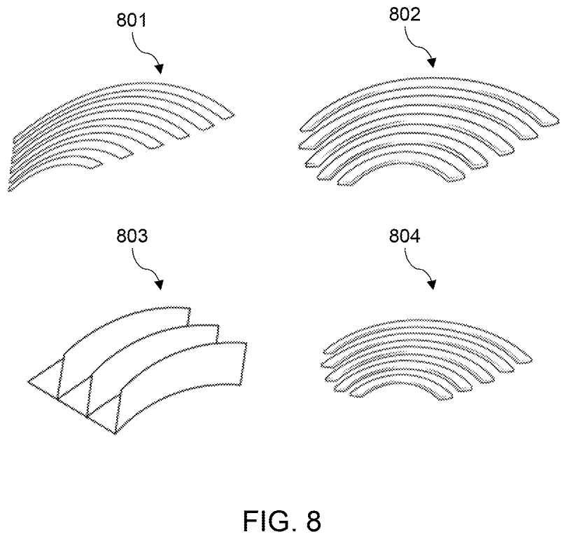

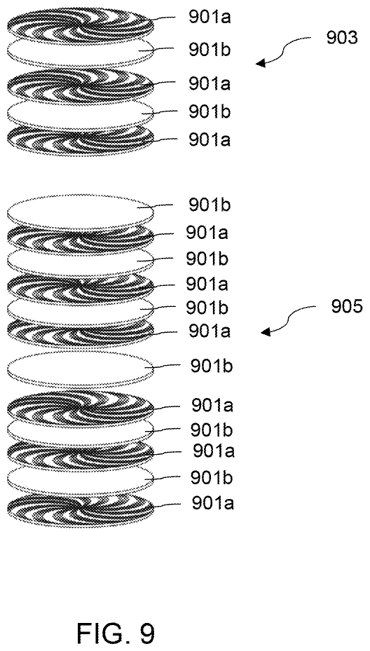

FIG. 1 illustrates an example apparatus 100 configured to mitigate a pathological response in an affected area of a body 102, in accordance with the present disclosure. FIG. 1 is described in conjunction with FIG. 2-7, elements 801-804 depicted in FIG. 8, and FIGS. 9-25.

The apparatus 100 may include a substrate 104 and a predefined three-dimensional negative-relief design pattern 106 formed on the substrate 104. The apparatus 100 may be positioned on or in close proximity to an affected area of the body (e.g., an area that is infected, damaged, wounded, or exhibiting chronic inflammation) to mitigate a pathological inflammatory response.

For example, in response to symptoms such as pain, redness, or swelling, the apparatus 100 may be applied to or near the affected area to facilitate reduction of such symptoms. In particular, the predefined design pattern 106 may contribute to reducing pain and inflammation. In certain implementations, application of the apparatus 100 may restore the electronegative potential of the epidermis (transepithelial potential, TEP), as well as the restore the zeta potential and electrical double layer associated with the zeta potential of red blood cells. The pattern 106 formed on the substrate 104 is a specialized design that is clinically tested to mitigate the pathological response of the affected area, when the pattern 106 is disposed in proximity to the affected area.

The predefined design pattern 106 may incorporate a combination of three-dimensional negative-relief, three-dimensional positive-relief or two-dimensional hologram predefined design pattern structures. Integration of these structural elements into the pattern 106 has been associated, in clinical testing, with measurable reductions in pain and restoration of the transepithelial potential and restoration of the red blood cell zeta potential when the apparatus is positioned on or near the affected area. In some embodiments, the predefined design pattern 106 may alternatively be implemented as a two-dimensional holographic structure configured to scatter light in a manner that produces a three-dimensional visual effect. Notably, a plurality of alternative three-dimensional negative relief designs was evaluated without producing comparable clinical outcomes, indicating that the specific configuration of the predefined design pattern 106 contributes to the observed effects.

The substrate 104 may be substantially circular and may be formed from rigid, semi-rigid, or flexible materials with varying degrees of transparency, elasticity, and durability. For example, the substrate 104 may comprise polymethyl methacrylate (PMMA), translucent thermoplastic polymers, thermoplastic polyurethane (TPU), or flexible biocompatible materials such as polyethylene terephthalate (PET), polyimide, liquid crystal polymer (LCP), polytetrafluoroethylene (PTFE), or polylactic acid (PLA). In some embodiments, the substrate may comprise a holographic material, including polyester films, biaxially oriented polypropylene, polyvinyl chloride, or acrylic photopolymers.

In certain implementations, the substrate 104 may be configured as a flexible patch adapted to adhere to the skin. Across clinically effective embodiments, the predefined design pattern 106 is implemented as either a three-dimensional relief structure (positive relief or negative relief) or a two-dimensional holographic configuration.

The predefined design pattern 106 may include a plurality of curvilinear structures 108 extending from a central portion 110 of the substrate 104 toward an outer boundary edge 112 that may be circular in certain embodiments. In certain embodiments, the curvilinear structures 108 are arranged in a substantially radial configuration, forming a repeating, symmetrical curvilinear pattern across the substrate.

In a preferred embodiment, each curvilinear structure 108 defines a curved segment, such as a semicircular arc, that originates at or near the central portion 110 and extends toward the outer edge 112. Each arc may be configured such that, if extended, it forms a complete circle having a diameter substantially equal to the radius of the substrate 104. The curvilinear structures 108 may be identical in length, curvature, and three-dimensional geometry.

The predefined design pattern 106 may comprise three-dimensional positive-relief or negative-relief features, or combinations thereof, arranged in a repeating configuration. In some embodiments, the pattern exhibits rotational symmetry, such as rotation through approximately 180 degrees or other angular intervals. In certain embodiments, rotational symmetry of approximately 180 has been observed to correspond with enhanced performance relative to higher order symmetries.

The surface geometry of each curvilinear structure 108 may be defined by a continuous, non-planar surface. In certain implementations, this surface may be described parametrically as a function of spatial coordinates (S(u, v)=(x(u, v), y(u, v), z(u, v)) where u and v are the two independent parameters such that the structure is generated by a curve swept along two independent parameters. Alternatively, the geometry may be defined implicitly by a function of x, y, and z that produces a non-flat, curved surface exhibiting variable curvature.

In some aspects, the curvilinear structures 108 on the substrate 104 are grouped in a plurality of sets S1, S2, S3, . . . Sn (collectively referred to as set S), where each set S includes a predefined count of curvilinear structures 108 (which may be greater than 1). In the exemplary aspect depicted in FIG. 1, a count of the sets S is 12 and the count of curvilinear structures 108 in each set is 6. Such a structure/arrangement/design of the pattern 106 has shown considerable positive response from patients in clinical testing. Specifically, when the pattern 106 depicted in FIG. 1 was placed on the affected areas of a plurality of patients, most of the patients reported considerable reduction in pain when the pattern 106/apparatus 100 was placed for some time duration (which may vary from 30 seconds to few hours, based on the severity of the pain) on the affected area.

In some aspects, the curvilinear structures 108 on the substrate 104 are grouped in a plurality of sets S1, S2, S3, . . . Sn (collectively referred to as set S), where each set S includes a predefined count of curvilinear structures 108 (which may be greater than 1). In the exemplary aspect depicted in FIG. 1, a count of the sets S is 12 and the count of curvilinear structures 108 in each set is 6. Such a structure/arrangement/design of the pattern 106 has shown considerable positive response from patients in clinical testing. Specifically, when the pattern 106 depicted in FIG. 1 was placed on the affected areas of a plurality of patients, most of the patients reported considerable reduction in pain when the pattern 106/apparatus 100 was placed for some time duration (which may vary from 30 seconds to few hours, based on the severity of the pain) on the affected area.

The placement/arrangement of the sets S on the substrate 104 is also an important factor in the efficacy of the apparatus 100 in reducing the pain (as determined by the clinical testing). The spatial arrangement of the sets S may be defined such that each set is positioned at a substantially uniform radial distance from adjacent sets. In an exemplary aspect, each set S is disposed at a predefined equivalent distance “D” (or radial distance “D”) from adjacent sets. The distance “D” may be defined as the distance between the closest curvilinear structures 108 of adjacent sets S, as shown in FIG. 1. This distance “D” may be greater than a distance “D1” (or a radial distance “D1”) between adjacent curvilinear structures 108 in the same set S, as shown in FIG. 1. Furthermore, the area between adjacent sets S may not include any curvilinear structure or may be planar. Stated another way, regions between adjacent sets may be substantially planar and free of curvilinear structures. Such an arrangement of the sets S and the curvilinear structures 108 has shown considerable positive response from patients in clinical testing.

The arrangement, spacing, and grouping of the curvilinear structures 108 and sets S may be selected to enhance the functional performance of the apparatus, including reduction of pain and modulation of inflammatory responses, as observed in clinical evaluations. In alternative embodiments, the number of sets, the number of curvilinear structures within each set, the spacing between structures, and the rotational orientation (e.g., clockwise or counterclockwise) may vary without departing from the scope of the present disclosure. The arrangement, spacing, and grouping of the curvilinear structures 108 and sets S may be selected to enhance the functional performance of the apparatus, including reduction of pain and modulation of inflammatory responses, as observed in clinical evaluations. In alternative embodiments, the number of sets, the number of curvilinear structures within each set, the spacing between structures, and the rotational orientation (e.g., clockwise or counterclockwise) may vary without departing from the scope of the present disclosure.

In additional aspects, while each curvilinear structure 108 may be circumferentially uniform in shape and dimensions, they may vary in rotational direction, spacing, line grouping (or the count of curvilinear structures 108 in each set S), the total count of curvilinear structures 108 included in the pattern 106 or formed on the substrate 104, structure, and/or the like. Examples of such different designs of the pattern 106 are depicted in FIG. 2-7, 801-804 and described below.

In certain embodiments, as illustrated in FIG. 1, each curvilinear structure 108 is oriented in a clockwise rotational direction. However, in alternative embodiments, each curvilinear structure 108 may instead be oriented in a counterclockwise rotational direction, as illustrated in FIG. 2. FIG. 2 depicts an apparatus 200, which may be substantially similar to apparatus 100 described above, except that the curvilinear structures 108 are oriented counterclockwise. Clinical testing has demonstrated that apparatus 200 exhibits substantially equivalent performance to apparatus 100, indicating that the direction of rotation (clockwise or counterclockwise) of the curvilinear structures 108 has minimal impact on the efficacy of the apparatus in reducing pain,

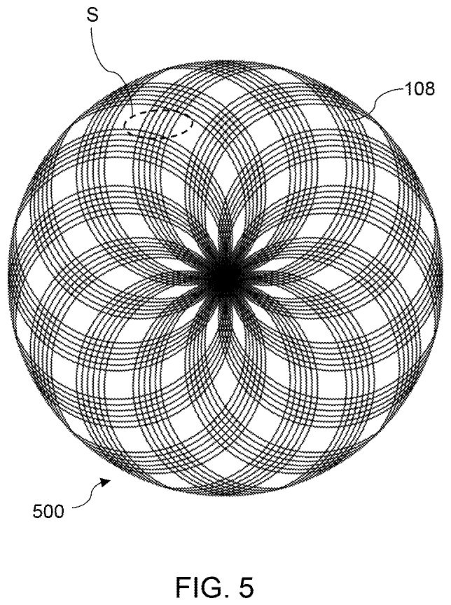

In some embodiments, the outer edge 110 of the substrate 104 is beveled. Additionally, embodiments incorporating a combination of clockwise and counterclockwise rotational orientations of the curvilinear structures 108, as referenced in FIG. 5, have also been determined to provide performance substantially equivalent to that of apparatus 100. Such combined-orientation embodiments are described in further detail below.

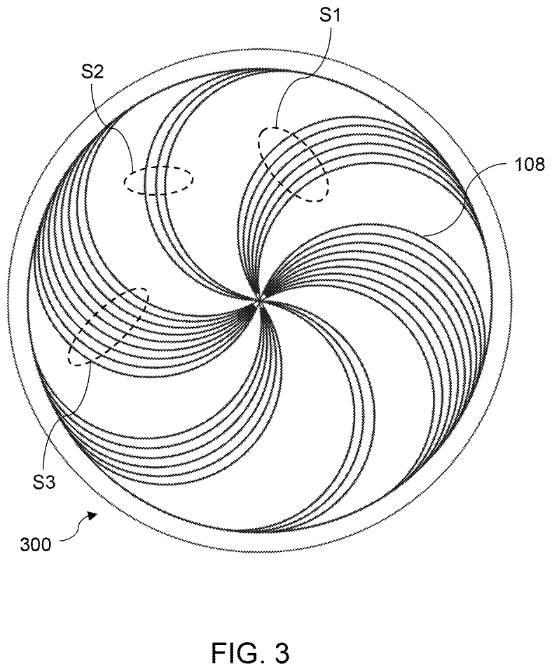

In certain embodiments, as shown in FIG. 1, the apparatus includes twelve sets S, each set comprising six curvilinear structures 108. In alternative embodiments, the number of sets S may be reduced to six, and each set may include, for example, three, six, or nine curvilinear structures 108, as illustrated in FIG. 3. Specifically, FIG. 3 depicts an apparatus 300 in which a first set S1 includes six curvilinear structures 108, a second set S2 includes three curvilinear structures 108, and a third set S3 includes nine curvilinear structures 108, with set S2 positioned between sets S1 and S3. The remaining sets may follow a similar arrangement and distribution. Such configurations have also demonstrated clinical efficacy in reducing patient pain.

Although FIG. 3 illustrates embodiments in which the curvilinear structures 108 are oriented in a clockwise direction, such depiction is not limiting. In other embodiments, the curvilinear structures 108 may be oriented counterclockwise without departing from the scope of the present disclosure.

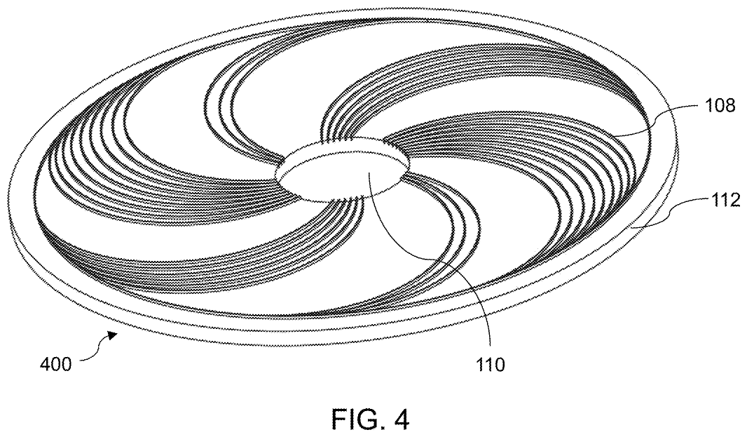

In certain embodiments, the center portion 110 of the substrate 104 is solid, as shown in FIG. 1. In alternative embodiments, the substrate 104 may include a through-hole formed in the center portion 110, as illustrated in FIG. 4. The outer edge 112 of the substrate 104 may also be beveled. The through-hole 110 may facilitate alignment or collimation of multiple apparatuses using a rod, tube, or similar structure. Such embodiments have also demonstrated efficacy in reducing pain as measured in clinical testing.

FIG. 5 illustrates an apparatus 500 that combines features of apparatuses 100 and 200. In particular, apparatus 500 may include twenty-four sets S, wherein a first group of twelve sets includes curvilinear structures 108 oriented in a clockwise direction, and a second group of twelve sets includes curvilinear structures 108 oriented in a counterclockwise direction. In some embodiments, each set S includes six curvilinear structures 108. Such configurations have demonstrated beneficial effects in reducing pain, as evidenced by patient responses in clinical evaluations.

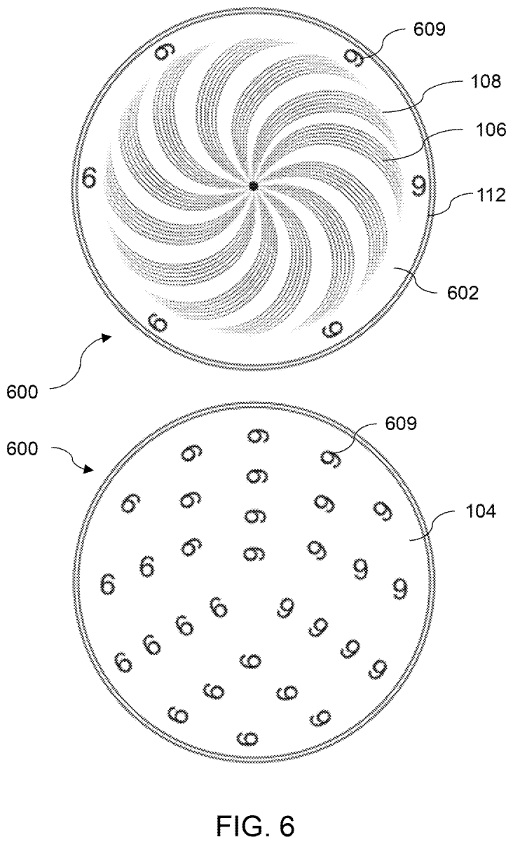

FIG. 6 illustrates an apparatus 600 having negative-relief etching on both sides of the substrate 104. A first side of the substrate includes curvilinear line patterns 106 corresponding to the curvilinear structures 108 described with respect to apparatus 100. Surrounding the outer edge 112 of the apparatus 600 is a circular region 602 including six design elements 609 spaced approximately 60 degrees apart. The outer edge 112 of the substrate 104 may be beveled.

An opposite surface of the apparatus 600 includes a plurality of concentric circular patterns incorporating design elements 609. In certain embodiments, the design elements 609 resemble an infinity symbol (or number symbols 1 to 9), with one portion of the symbol being incomplete. On the above referenced opposite surface an innermost circle may include three 609 design elements spaced approximately 120 degrees apart. A next outer circle may include six 609 design elements spaced approximately 60 degrees apart, followed by a circle having nine 609 design elements spaced approximately 40 degrees apart, and an outermost circle having twelve 609 design elements spaced approximately 30 degrees apart. The inclusion of such design elements 609 has been observed to enhance pain reduction when the apparatus is placed on or in proximity to the skin.

In certain embodiments, one or more number symbols from 1 to 9 are placed surrounding the predefined geometric pattern and placed on the opposite side of the apparatus in geometric patterns, as depicted in FIG. 6 and described above.

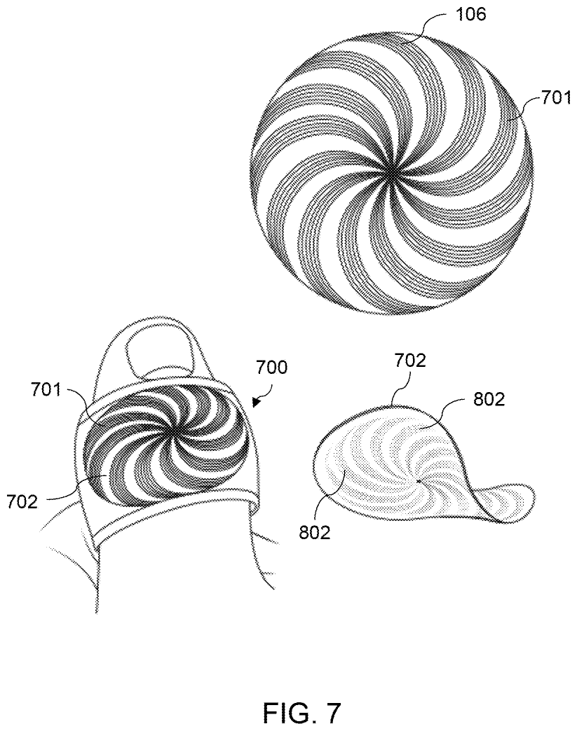

FIG. 7 illustrates apparatus 700 that may comprise a flexible or semiflexible biocompaable substrate 702 with a design pattern 106 formed as positive-relief, three-dimensional structures 802-803 of FIG. 8 or two dimensional structures 804 of FIG. 8. In some embodiments, the substrate 802 may comprise a transparent polyimide (PI) or a liquid crystal polymer (LCP), optionally coated with a biocompatible conformal coating such as parylene. The conductive ridges 701 (which form the design pattern 106) may comprise copper or another suitable conductive material adhered. When placed on or in proximity to the skin, the apparatus 700 may reduce pain, heat, and redness associated with underlying inflammatory conditions.

FIG. 8 illustrates four embodiments of curvilinear patterns having differing relief geometries. Embodiment 801 illustrates a three-dimensional negative-relief curvilinear pattern manufactured by commercial laser etching process. Embodiment 802 illustrates a three-dimensional positive-relief curvilinear pattern manufactured by the printed circuit board (PCB) manufacturing process. Embodiment 803 a three-dimensional positive relief curvilinear pattern manufactured by the polymer casting process. Embodiment 804 a two-dimensional no relief curvilinear pattern manufactured by microscopic interference patterns manufactured by a laser on a photosensitive material embossed to reproduce a three-dimensional light field.

FIG. 9 depicts an example of a plurality of apparatuses axially aligned and adhered together to mitigate a pathological response of an affected area of a body in accordance with the present disclosure. Specifically, FIG. 9 illustrates apparatus assemblies 903 and 905 including a plurality of apparatus elements 901A, 901B arranged in axial alignment and coupled by adhesive discs 902A. Each apparatus element 901A comprises any of apparatuses described above and includes a plurality of curvilinear structures corresponding to one or more of the configurations illustrated in FIG. 8. The apparatus assembly 903, 905 is receivable within an enclosure configured to retain the apparatus assembly in proximity to a body surface.

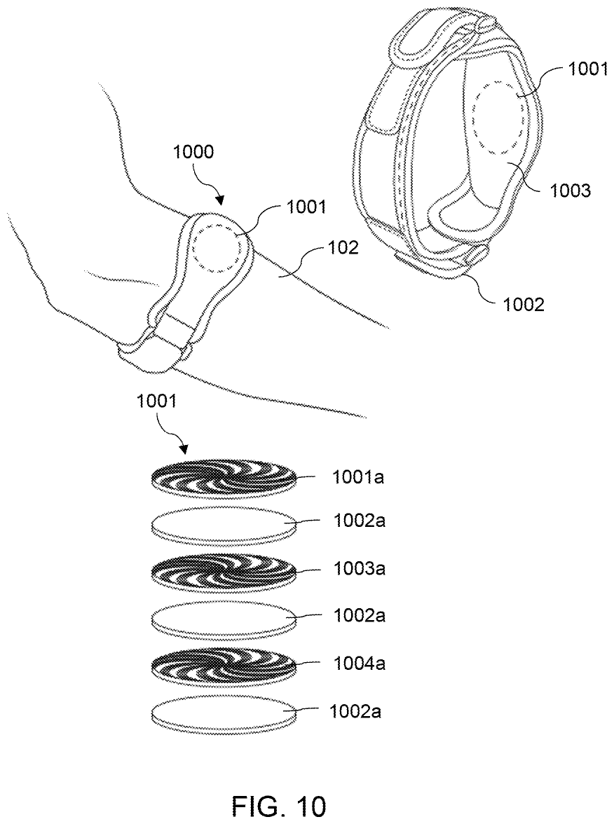

FIG. 10 depicts an example of an elbow brace 1000 comprised of apparatuses to mitigate a pathological response of an affected area of a body in accordance with the present disclosure. Specifically, FIG. 10 illustrates a lateral epicondyle brace 1000 including at least one apparatus 1001. The apparatus 1001 comprises one or more disc-shaped elements (e.g., 1001A, 1003A, 1004A) arranged in axial alignment and coupled by an adhesive layer 1002A. The adhesive layer 1002A comprises a biocompatible material and is disposed between adjacent disc-shaped elements. Each disc-shaped element comprises a substrate and a plurality of curvilinear structures formed thereon, wherein the curvilinear structures correspond to any of the patterns described with respect to FIG. 8 and the apparatuses described above.

The apparatus 1001 may be placed within the lateral epicondylar brace, with one or more layers of fabric forming the brace, separating apparatus 1001 from the skin. The apparatus 3201 is securable to a support structure including, but not limited to, a brace, splint, orthotic device, sleeve, or garment. Attachment may be achieved using one or more of adhesive layers, hook-and-loop fasteners, straps, or mechanical retainers.

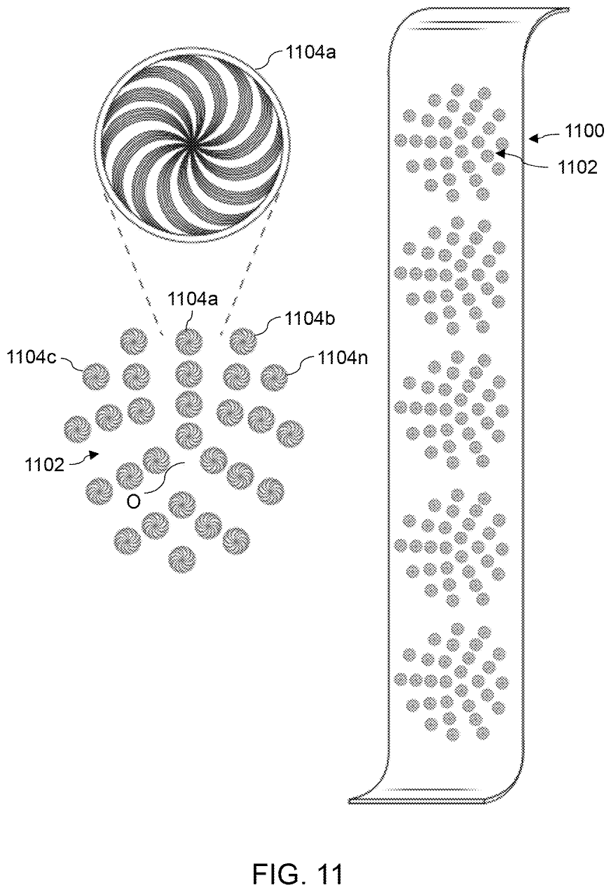

FIG. 11 depicts an example pattern 1102 (or a geometric array) of apparatuses 1104a, 1104b, 1104c, 1104n (collectively referred to as apparatuses 1104) to mitigate a pathological response of an affected area of a body in accordance with the present disclosure. Element 1100 depicts a kinesiology sports tape (or an elastic tape 1100) in which multiple patterns 1102 are printed/formed/pasted adjacent to each other. The apparatus 1104 may be similar to any of the apparatuses described above (e.g., the apparatus 100, or any other apparatus described above).

The tape 1100 may be an elastic therapeutic tape designed to support muscles, joints, and tendons without restricting movement. It may be the same as the kinesiology tape that is widely used in sports, physical therapy, and rehabilitation to aid in injury prevention, pain relief, and enhanced performance. Multiple patterns 1102 may be printed/formed/pasted on the flexible fabric of the tape 1100. Each apparatus 1104 may include may include a single disc/substrate (similar to the substrate 104 described above) or may include a plurality of collimated discs/substrates. Multiple apparatuses 1104 may be arranged in a plurality of concentric circles about a central point “O” in a circular geometric pattern to form the pattern 1102, which when printed on the tape 1100 enhances its clinical effectiveness. In the exemplary aspect depicted in FIG. 11, the pattern includes 3 apparatuses in the smallest circle (closest to the center point “O) positioned 120 degrees apart, followed by 6 apparatuses in the adjacent larger circle positioned 60 degrees apart, followed by 9 apparatuses in the adjacent larger circle positioned 40 degrees apart, and then followed by 12 apparatuses in the outermost circle positioned 30 degrees apart. The radii of the four circles may be whole number multiples of Phi (1.618). This forms a single pattern 1102 of 30 apparatuses.

The geometric pattern 1102 of these thirty separate apparatuses 1104 is repeated throughout the length of the tape 1100 with a predetermined spacing of the geometric patterns. In some aspects, the patterns 1102 may be printed on flexible substrates such as thermoplastic polyurethane. In other aspects, the apparatuses 1104 or their substrates may be attached to the elastomeric kinesthetic tape by means of a medical-grade adhesive. The apparatuses 1104 or their substrates may be composed of liquid or paste printing inks. Liquid inks may be, for example, gravure, flexo, inkjet, electrographic, electroconductive, electrophotographic inks, and/or the like.

In certain embodiments, the elastic tape 1100 includes a plurality of apparatus elements 1104 disposed thereon. The apparatus elements 1104 are arranged in a distributed pattern across the tape 1100. Each apparatus element comprises a substrate and a plurality of curvilinear structures corresponding to any of the configurations described above. Each apparatus element 1104 is independently coupled to the elastic tape 1100 such that the elasticity of the tape is maintained between adjacent apparatus elements. The elastic tape 1100 comprises elastomeric material selected from cotton-based or synthetic compositions.

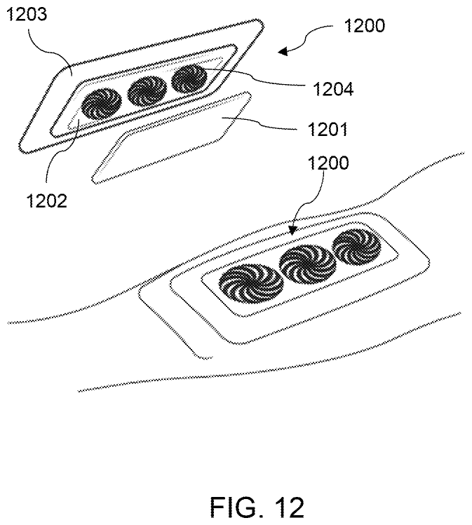

FIG. 12 depicts an example wound dressing in accordance with the present disclosure. Specifically, FIG. 12 illustrates a wound dressing assembly 1200 including an apparatus 1204 disposed within a multilayer dressing structure. The apparatus 1204 comprises a substrate having a plurality of curvilinear structures formed thereon, the curvilinear structures corresponding to one or more of the configurations illustrated in FIG. 8 (specifically the views 1202 and 1204). The apparatus 1204 is coupled to a central pad 1202 by a biocompatible adhesive.

The wound dressing assembly 1200 further comprises a wound contact layer 1201 disposed on a first side of the central pad 1202 and an outer backing layer 1203 disposed on an opposite side of the central pad 1202. The apparatus 1204 is positioned between the central pad 1202 and the outer backing layer 1203.

The apparatus 1204 is incorporable into a dressing selected from the group consisting of hydrocolloid dressings, hydrogel dressings, collagen dressings, alginate dressings, polyurethane foam dressings, and film dressings, wherein the apparatus 1204 is disposed between a dressing layer configured to contact a wound surface and an outer backing layer.

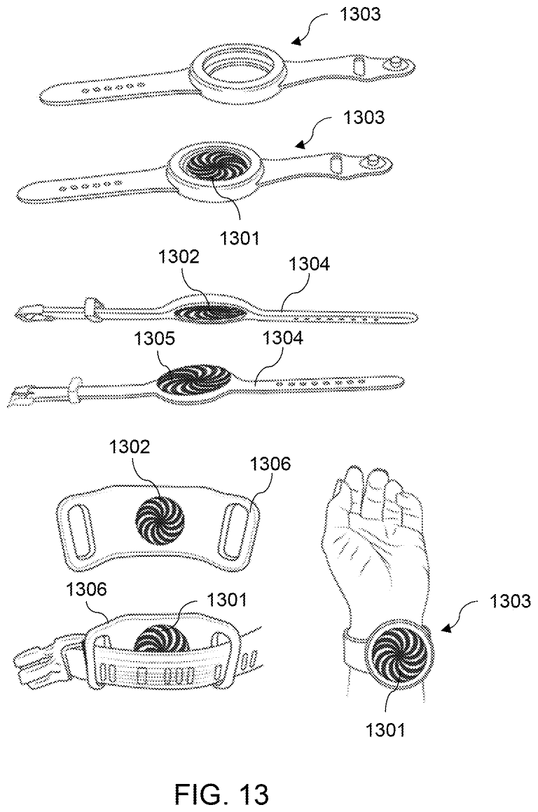

FIG. 13 depicts an example pattern of apparatus incorporated in a wrist band to mitigate a pathological response of an affected area of a body in accordance with the present disclosure. Specifically, FIG. 13 illustrates wrist-mounted systems including a first wristband 1303 carrying an apparatus 1301 and a second wristband 1304 carrying an apparatus 3802. The wristband 1304 comprises positive relief 1305 molded into the central portion holding apparatus/wristband 1304. A third wristband apparatus 1306 is shown that comprises a central portion holding apparatus 1301 similar to wristband 1303. The apparatus 1306 is configured with two rectangular holes that allow bands of varying length to be placed through the holes to attach the apparatus 1301 to additional anatomic structures including, but not limited to, ankles, legs, thighs, forearms elbows and arms. The apparatuses 1301 and 1302 may comprise a plurality of apparatus elements corresponding to any of apparatuses described above, where each apparatus element includes a substrate and a plurality of curvilinear structures corresponding to one or more of the configurations illustrated in FIG. 8.

The apparatuses 1301 and 1302 comprise at least one apparatus element including a substrate having a first surface and a second surface. The first surface includes curvilinear structures corresponding to one or more of the configurations illustrated in the views 802 and 804 of FIG. 8, and the second surface includes curvilinear structures corresponding to the configuration illustrated in the view 1303.

Each wristband 1303, 1304 and 1306 comprises a fastening mechanism selected from the group consisting of buckles, magnetic closures, and mechanical engagement features including studs and apertures. Each wristband is configurable to be secured around a wrist, forearm, arm, ankle, leg, and thigh.

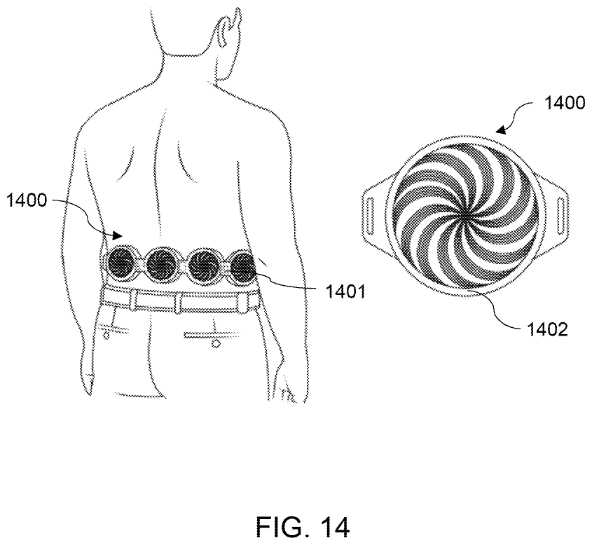

FIG. 14 depicts an example of an apparatus placed within an open silicon enclosure to mitigate a pathological response of a body in accordance with the present disclosure. Specifically, FIG. 14 illustrates an apparatus system 1400 including a plurality of apparatus elements coupled to a support structure. The support structure comprises a belt 1401 and an enclosure 1402. The enclosure 1402 is configured to receive and retain a plurality of apparatus elements therein.

The plurality of apparatus elements includes a first set of rigid elements and a second set of flexible or semi-flexible elements. Each apparatus element comprises a substrate and a plurality of curvilinear structures corresponding to one or more of the configurations illustrated in the views 801, 802, 803 and 804 of FIG. 8. The apparatus elements are retained within the enclosure 802 in a predetermined arrangement.

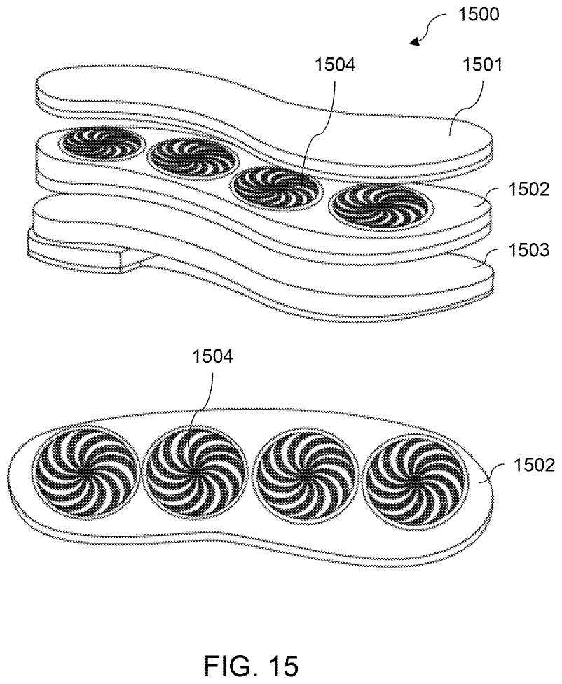

FIG. 15 depicts a foot orthotic to mitigate a pathological response of an affected area of a body in accordance with the present disclosure. Specifically, FIG. 15 illustrates a foot orthotic 1500 including a multilayer structure. The multilayer structure comprises a top layer 1501, an intermediate layer 1502, and a base layer 1503. The intermediate layer 1502 includes at least one apparatus 1504 coupled thereto.

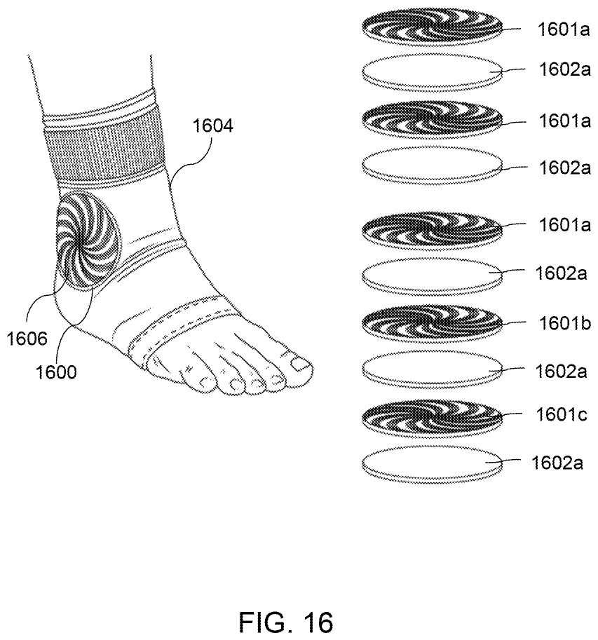

FIG. 16 depicts an example of an ankle brace apparatus to mitigate a pathological response of an affected area of a body in accordance with the present disclosure. Specifically, FIG. 16 illustrates a compressive ankle brace 1604 including at least one apparatus 1600. The apparatus 1600 comprises a plurality of elements 1601a, 1601b, 1601c arranged along a common axis and coupled by an adhesive disc 1602a. Each of the elements 1601a-1601c comprises an apparatus 1606 including a substrate and a plurality of curvilinear structures corresponding to one or more of the configurations illustrated in FIG. 8. The apparatus 1600 is disposed within or on the compressive ankle brace 1604 such that the apparatus 1600 is positionable adjacent to an anatomical region of the ankle.

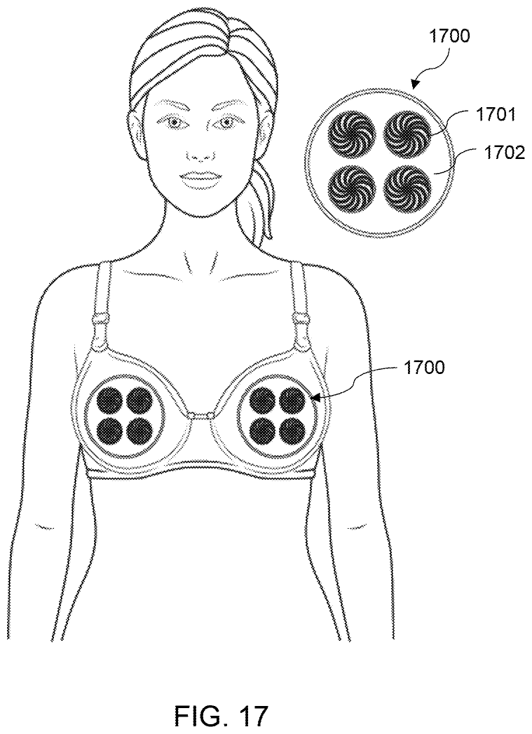

FIG. 17 depicts an example of a plurality of apparatuses positioned within a bra cup to mitigate a pathological response of an affected area of a body in accordance with the present disclosure. Specifically, FIG. 17 illustrates a breast interface assembly 1700 including a pad structure 1702 and a plurality of apparatuses 1701 coupled thereto. The pad structure 1702 is shaped to conform to a breast and is positionable within a garment. Each apparatus 1701 is coupled to the pad structure 1702 via a biocompatible adhesive and comprises a flexible or semi-flexible substrate having a plurality of curvilinear structures formed thereon. The curvilinear structures correspond to any of the configurations described with respect to the apparatuses and FIG. 8 described above. In some embodiments, the apparatuses 1701 are distributed across the pad structure 1702 in a predefined spatial arrangement.

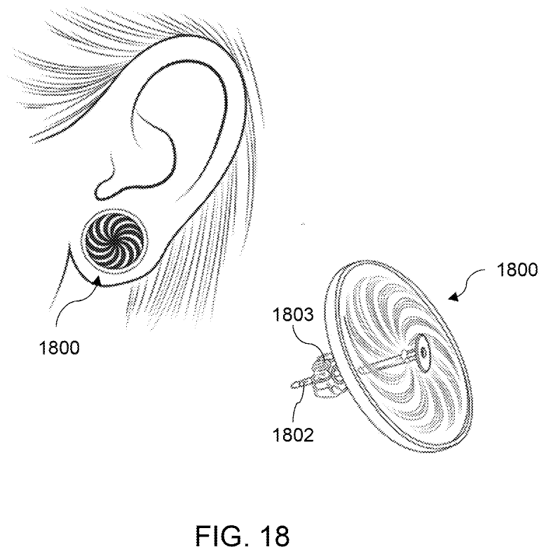

FIG. 18 depicts an example of an apparatus in contact with an ear lobe to mitigate a pathological response of an affected area of a body in accordance with the present disclosure. Specifically, FIG. 18 illustrates an earring assembly 1800 including an apparatus 1801. The apparatus 1801 defines a central aperture configured to receive an earring post 1802. The curvilinear structures correspond to any of the configurations described with respect to the apparatuses and FIG. 8 described above. The earring post 1802 extends through the central aperture of the apparatus 1801 and through an opening in an earlobe, and is secured by an earring back 1803.

The apparatus 1800 comprises one or more rigid layers and one or more flexible layers. Each layer corresponds to any of apparatuses described above and includes a substrate having a plurality of curvilinear structures formed thereon. The curvilinear structures correspond to one or more of the configurations illustrated in the views 801, 802 and 804 of FIG. 8. The flexible layer may be coupled to the rigid layer

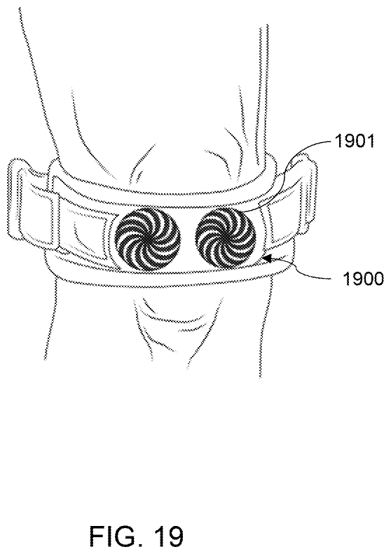

FIG. 19 depicts an example of an apparatus incorporated in a knee brace to mitigate a pathological response of an affected area of a body in accordance with the present disclosure. Specifically, FIG. 19 illustrates a patellar tendon brace assembly 1900 including a brace and a plurality of apparatuses positioned relative to the brace. The plurality of apparatuses 1901 correspond to any of apparatuses described above and are positioned on or within the brace such that, when worn, the apparatuses are disposed adjacent to medial and lateral regions of a patellar tendon. The curvilinear structures correspond to any of the configurations described with respect to the apparatuses and FIG. 8 described above. The brace comprises a support structure configured to retain the plurality of apparatuses in fixed positions relative to the patellar tendon.

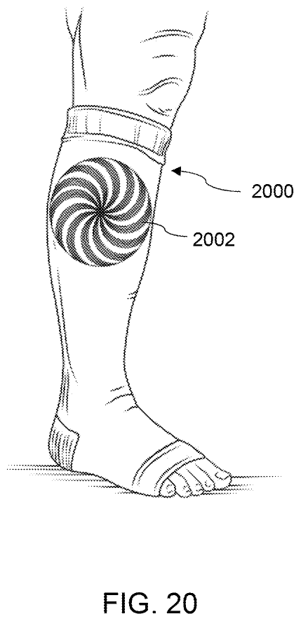

FIG. 20 depicts an example of an apparatus incorporated in knee-high compressive stockings to mitigate a pathological response of an affected area of a body in accordance with the present disclosure. Specifically, FIG. 20 illustrates a compressive stocking system 2000 including at least one apparatus 2002. The apparatus 2002 is positioned between a compressive stocking and a user's leg. The apparatus 2002 comprises a flexible substrate having a plurality of curvilinear structures formed thereon. A plurality of apparatuses 2002 are distributed at spaced locations between the compressive stocking and the leg. The curvilinear structures correspond to any of the configurations described with respect to the apparatuses and FIG. 8 described above. The intended use is for chronic and acute and chronic lymphedema and acute hematomas.

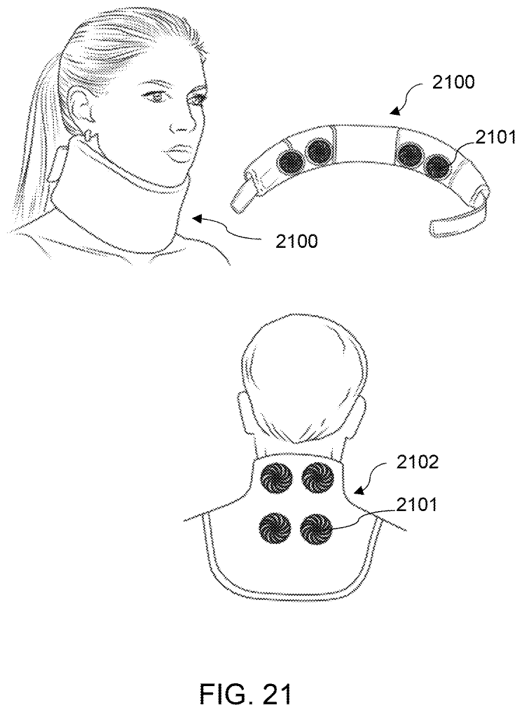

FIG. 21 depicts an example of an apparatus incorporated in a neck brace and clothing apparel to mitigate a pathological response of an affected area of a body in accordance with the present disclosure. Specifically, FIG. 21 illustrates a cervical collar assembly 2100 including at least one apparatus 2101. The cervical collar 2100 comprises a support structure configured to engage a neck region and to retain the apparatus 2101 in contact or in close proximity to the neck. The apparatus 2101 comprises one or more rigid layers and one or more flexible layers that are positioned within or on the surface of the cervical collar. In addition, one or more apparatus 2101 may be positioned on or within a neck dickie 2102. Each layer corresponds to any of apparatuses described above and includes a plurality of curvilinear structures corresponding to one or more of the configurations illustrated in the views 801-804 of FIG. 8. The flexible layer is coupled to the rigid layer.

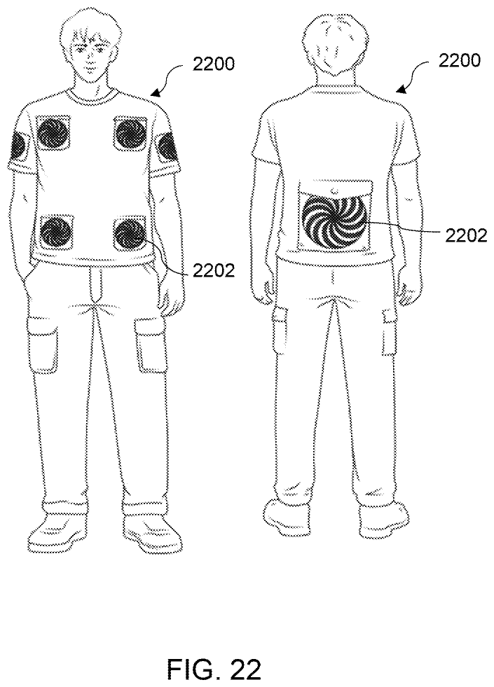

FIG. 22 depicts an example of clothing apparel to mitigate a pathological response of an affected area of a body in accordance with the present disclosure. Specifically, FIG. 22 illustrates a garment 2200 including a plurality of pockets configured to receive a plurality of apparatuses 2202. Each apparatus corresponds to any of apparatuses described above and comprises one or more rigid layers and one or more flexible layers. Each layer includes a substrate having a plurality of curvilinear structures corresponding to one or more of the configurations illustrated in the views 801-804 of FIG. 8, wherein the flexible layer is coupled to the rigid layer. The plurality of pockets is positioned on the garment to retain the plurality of apparatuses at predefined locations relative to a wearer's body. The intended use is for chronic and acute neck pain, post-surgical pain and edema and radiculopathy originating in the neuroforaminal recesses and spinal cord.

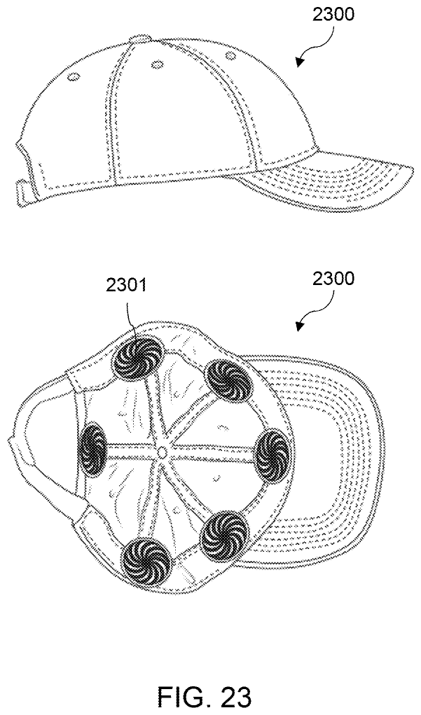

FIG. 23 depicts an example of a plurality of apparatuses positioned within a hat/cap to mitigate a pathological response of an affected area of a body in accordance with the present disclosure. Specifically, FIG. 23 illustrates a head covering 2300 including at least one apparatus 32301. The apparatus 2301 is disposed on an inner surface of the head covering 2300 such that, when worn, the apparatus 2301 is positioned between the head covering and a user's scalp. In certain embodiments, a plurality of apparatuses 2301 are circumferentially distributed along an inner perimeter of the head covering 2300. Each apparatus 2301 comprises a substrate and a plurality of curvilinear structures corresponding to any of the configurations described with respect to the apparatuses and FIG. 8 described above.

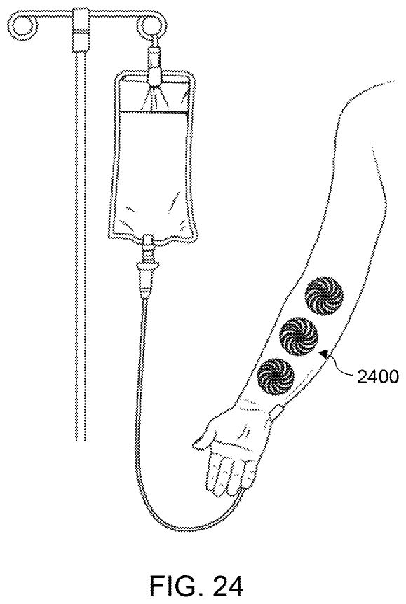

FIG. 24 depicts an example of a plurality of apparatuses (100-700) positioned on the forearm over the watershed veins receiving intravenous fluids during IV therapy in accordance with the present disclosure. Specifically, FIG. 24 illustrates a forearm assembly 2400 including a plurality of apparatuses positioned on a forearm adjacent over the watershed veins. Each apparatus corresponds to any of apparatuses described above and includes a substrate having a plurality of curvilinear structures corresponding to one or more of the configurations illustrated corresponding to any of the configurations described with respect to the apparatuses and FIG. 8. The plurality of apparatuses is retained against the forearm by at least one of a compressive sleeve, an adhesive tape, or a wrap.

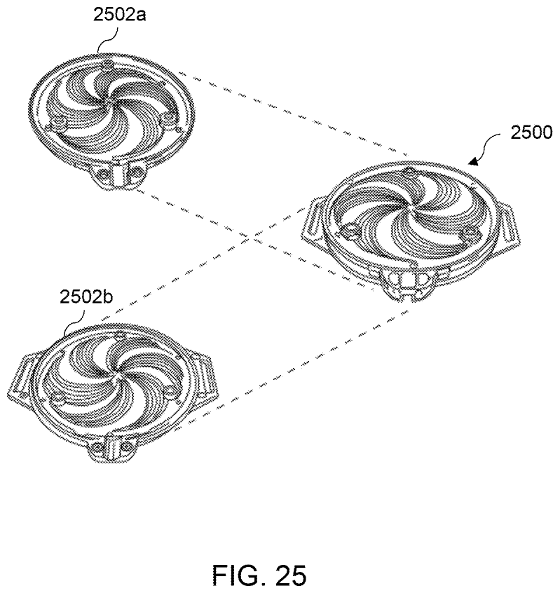

FIG. 25 depicts an example of an enclosure apparatus in accordance with the present disclosure. Specifically, FIG. 25 illustrates an enclosure 2500 including an upper surface 2502a and a lower surface 2502b coupled to define an internal volume. The upper surface 2502a and the lower surface 2502b each include inward-facing surfaces having a plurality of predefined three-dimensional curvilinear structures corresponding to one or more of the configurations illustrated in the views corresponding to any of the configurations described with respect to curvilinear lines 801 to 804 and FIG. 8. The enclosure 2500 is free of electronic components. The upper surface 2502a and the lower surface 2502b comprise a polymer material selected from acrylonitrile butadiene styrene (ABS), polycarbonate (PC), or blends thereof. Application of enclosure 2500 when placed on or in close proximity to areas of inflammation may reduce the inflammatory response of the body. The disclosed enclosure 2500 may be combined with a phototherapy light emitting device and a magnetic field generating device to perform enhanced phototherapy and magnetotherapy (such devices are disclosed in US patent application Ser. Nos. 18/496,374 and 18/496,370 and incorporated by reference in their entireties in the present disclosure).

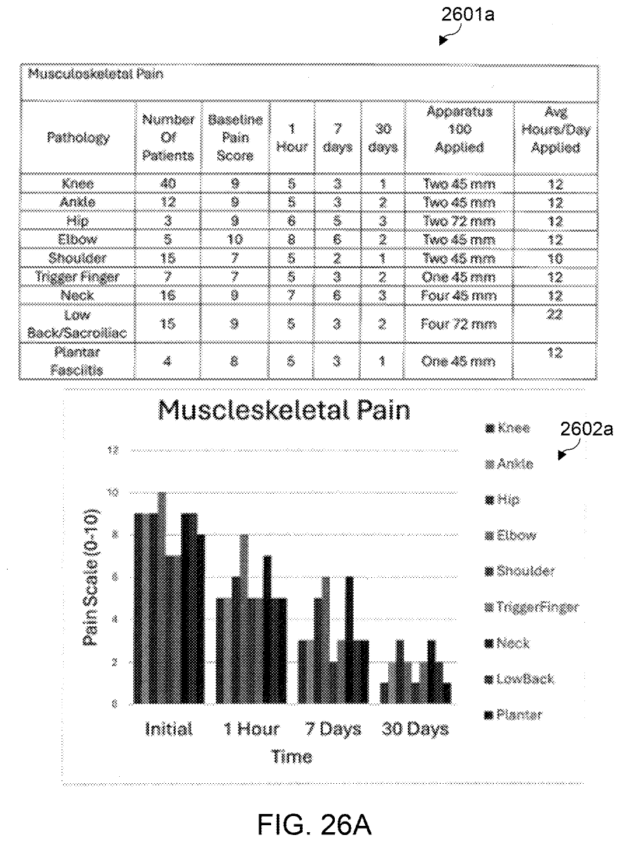

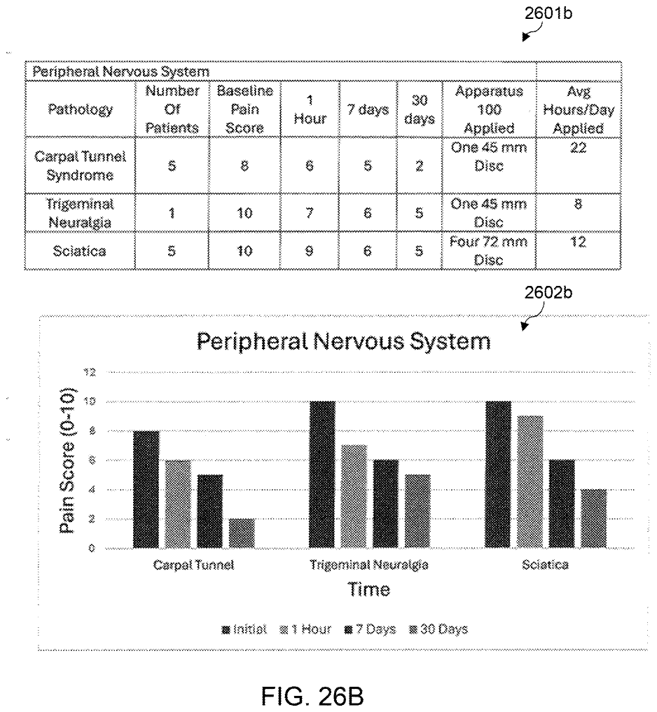

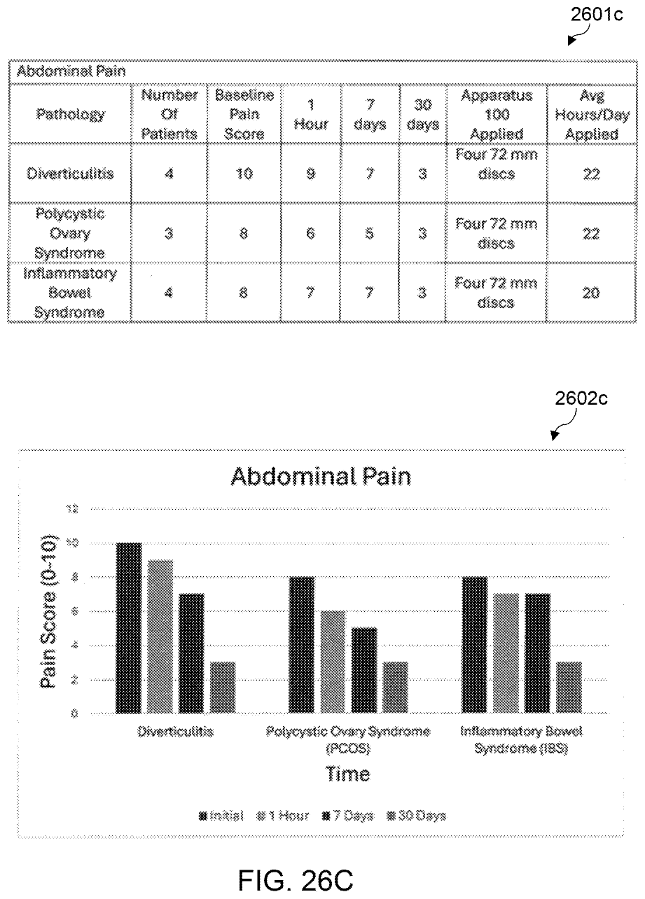

FIG. 26A depicts example tables and graphs illustrating patient responses in accordance with the present disclosure. Specifically, FIG. 26A illustrates a data presentation 2601a and a corresponding graphical representation 2602a. The data presentation 2601a includes aggregated values corresponding to reported pain levels at multiple time intervals, including an initial measurement, a measurement obtained approximately one hour after application, a measurement obtained approximately seven days after application, and a measurement obtained approximately thirty days after application. The data set represented in FIG. 26A is derived from a population of 117 subjects categorized across multiple musculoskeletal conditions.

FIG. 26B depicts further example tables and graphs illustrating patient responses in accordance with the present disclosure. Specifically, FIG. 26B illustrates a data presentation 2601b and a corresponding graphical representation 2602b. The data presentation 2601b includes aggregated values corresponding to reported pain levels at the same time intervals described with respect to FIG. 26A. The data set represented in FIG. 26B is derived from a population of 11 subjects categorized across peripheral nervous system conditions.

FIG. 26C depicts further example tables and graphs illustrating patient responses in accordance with the present disclosure. Specifically, FIG. 26C illustrates a data presentation 4801c and a corresponding graphical representation 2602c. The data presentation 2601c includes aggregated values corresponding to reported pain levels at the same time intervals described with respect to FIG. 26A. The data set represented in FIG. 26C is derived from a population of 11 subjects categorized across gastrointestinal and gynecological conditions.

The reported pain levels are based on a numerical rating scale ranging from 0 to 10, wherein 0 corresponds to an absence of pain and 10 corresponds to a maximum reported pain level. The data represented in FIGS. 26A-26C is associated with subjects to whom at least one of apparatus 100 or apparatus 3000 was applied. The data presentations 2601a-2601c and corresponding graphical representations 2602a-2602c are provided for illustrative purposes and do not limit the scope of the present disclosure.

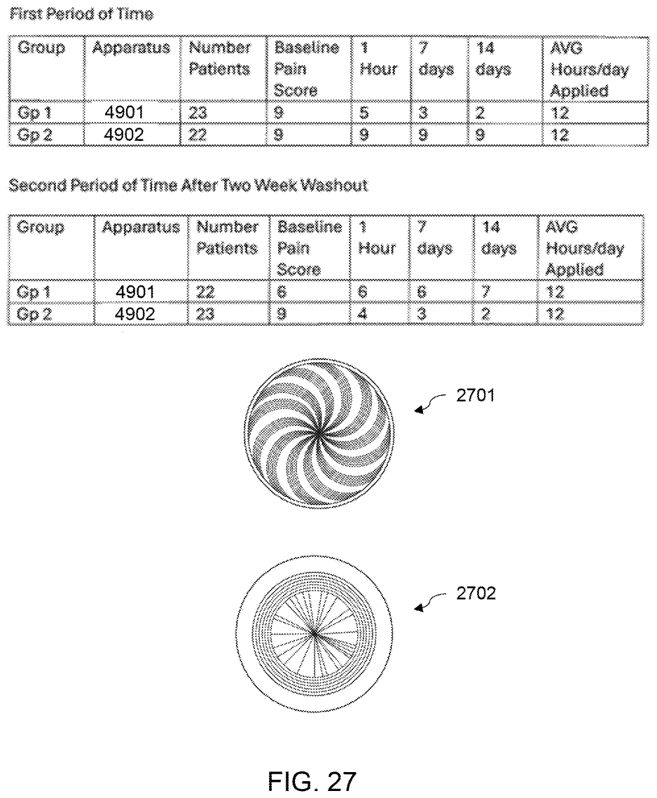

FIG. 27 depicts an example of a crossover study in accordance with the present disclosure. Specifically, FIG. 27 depicts a pilot double-cross-over study of knee osteoarthritis with 23 patients randomized to Gp 1 and 22 patients randomized to Gp 2. The patients were blinded to the treatment received. Apparatus 2701 was associated with consistent reductions in pain scores across both treatment periods, whereas apparatus 2702 showed little to no improvement. Across the two apparatus 2701 exposures, mean pain score declined from 9.0 at baseline to 4.5 at 1 hour, 3.0 at 7 days, and 2.0 at 14 days, corresponding to mean reductions of 50.0%, 66.7%, and 77.8%, respectively. Across the two apparatus 2702 exposures, mean pain score remained unchanged from baseline through 7 days and increased slightly by day 14. These descriptive findings suggest a substantial analgesic effect of the apparatus 2701 relative to the apparatus 2702. This pilot dataset supports the conclusion that the apparatus 2701 outperformed the apparatus 2702 for short-term pain reduction in knee osteoarthritis. The signal was large and internally consistent across both crossover periods.

Examples of clinical cases using apparatus 100 are described below. The clinical cases are for illustrative purposes only and should not be construed as limiting or exhaustive.

In a first clinical case, a 56-year-old male with low back pain focused on the right sacroiliac articulation was seen in clinic. The sacroiliac joint pain was initiated secondary to a motor vehicle accident 20 years prior. Physical examination revealed maximum tenderness over the right sacroiliac articulation. Past treatments and therapy included numerous sacroiliac joint injections and numerous rounds of physical therapy. To control the pain symptoms, the patient required long-term pain medications. Application of three apparatus 100 over the right sacroiliac articulation reduced the pain from a level of 8 to a level of 3 within half an hour after initial application. Continued application of the three apparatus 100 over the right sacroiliac articulation during the following four weeks resolved to a pain level of two (2).

In a second clinical case, a 69-year-old male presented with six-month history of progressive pain in the plantar (bottom) region of his right foot, with maximum pain at the calcaneal (heel) insertion of the plantar fascia (diagnosed plantar fasciitis). The pain was aggravated by weight bearing, which was most noticeable upon first weight bearing in the morning. Application of one apparatus 100 over the origin of the plantar fascia at the calcaneus (heel) reduced the pain from an eight (8) to a level of two (2) within half an hour. Continued application of one apparatus 100 over the plantar fascia during the following four weeks resolved the foot pain.

In a third clinical case, a 62-year-old female presented with a complex history of lower abdominal pain secondary to multiple abdominal surgeries. Six years prior, the patient had a portion of her large intestine surgically removed secondary to a diagnosis of adenocarcinoma. A postoperative complication of peritonitis resulted in a breakdown of the surgical incision, requiring a colostomy. After multiple abdominal procedures, the abdominal wound closed, and the colostomy was removed with a reconnection of the colon. The multiple surgeries over a seven-month period resulted in significant abdominal scar tissue and chronic abdominal pain. Application of three apparatus 100 over painful areas in the lower abdomen reduced the chronic abdominal pain from a level of eight (8) to a level of three (3) within the first half hour. Continued application of the three apparatus 100 for the next three months resulted in further reducing the pain level between one (1) and three (3).

In a fourth clinical case, a 75-year-old male presented with chronic pain in his right shoulder secondary to a traumatic injury from a fall on the right shoulder. At the initial clinic visit, the patient was found to have acute chronic rotator cuff tendonitis with a pain level of eight (8). Prior to this office visit, the patient had tried several therapeutic modalities that did not reduce the pain. One apparatus 100 was applied to the area of pain over the rotator cuff of the right shoulder, resulting in a level of pain reduction from an eight (8) to a three (3) within half an hour. After four weeks of apparatus 100 application to twelve (12) hours per day, the patient reported he had a pain level of one (1).

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments, whether or not explicitly described.

Further, where appropriate, the functions described herein can be performed in one or more of hardware, software, firmware, digital components, or analog components. For example, one or more application-specific integrated circuits (ASICs) can be programmed to carry out one or more of the systems and procedures described herein. Certain terms are used throughout the description, and claims refer to particular system components. As one skilled in the art will appreciate, components may be referred to by different names. This document does not intend to distinguish between components that differ in name but not function.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. Further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. An apparatus configured to modulate a physiological response of biological tissue, comprising:
a substrate having a central region and an outer boundary; and
a predefined geometric pattern disposed on the substrate, the predefined geometric pattern comprising a plurality of continuous non-intersecting curvilinear structures extending radially from the central region toward the outer boundary,
wherein:
(a) each curvilinear structure defines a non-intersecting non-linear path;
(b) adjacent curvilinear structures are separated by predefined spatial relationships;
(c) the plurality of curvilinear structures collectively defines a distributed geometric interface configured for placement on or adjacent to biological tissue; and
(d) placement of the apparatus on or adjacent to biological tissue is associated with modulation of at least one physiological parameter associated with inflammation.

2. The apparatus of claim 1, wherein the substrate is substantially circular.

3. The apparatus of claim 1, wherein each curvilinear structure corresponds to a portion of a circle.

4. The apparatus of claim 1, wherein each curvilinear structure, if extended, defines a complete circular geometry.

5. The apparatus of claim 1, wherein the curvilinear structures comprise three-dimensional positive-relief curvilinear structures.

6. The apparatus of claim 5, wherein the relief features comprise negative-relief curvilinear structures.

7. The apparatus of claim 5, wherein the relief features comprise positive-relief conductive and non-conductive curvilinear lines.

8. The apparatus of claim 1, wherein the predefined geometric pattern comprises a holographic surface pattern.

9. The apparatus of claim 1, wherein the curvilinear structures are arranged in a clockwise and/or counterclockwise rotational orientation.

10. The apparatus of claim 1, wherein the predefined geometric pattern comprises both clockwise-oriented and counterclockwise-oriented curvilinear structures.

11. The apparatus of claim 1, wherein the curvilinear structures are organized into a plurality of sets.

12. The apparatus of claim 11, wherein a first spacing between adjacent sets differs from a second spacing between adjacent curvilinear structures within a set.

13. The apparatus of claim 11, wherein regions between adjacent sets are substantially free of curvilinear structures.

14. The apparatus of claim 11, wherein each set comprises between three and twelve curvilinear structures.

15. The apparatus of claim 1, wherein the substrate comprises a flexible polymeric material.

16. The apparatus of claim 15, wherein the flexible polymeric material comprises polyethylene terephthalate (PET), liquid crystal polymer (LCP), polytetrafluoroethylene (PTFE), polyurethane, polymethyl methacrylate (PMMA), or polylactic acid (PLA).

17. The apparatus of claim 1, wherein one or more number symbols from 1 to 9 are placed surrounding the predefined geometric pattern and placed on the opposite side of the apparatus in geometric patterns.

18. The apparatus of claim 1, wherein the apparatus is configured for direct skin contact.

19. The apparatus of claim 1, wherein the apparatus operates without externally applied electrical stimulation.

20. The apparatus of claim 1, wherein the predefined geometric pattern is configured to modulate transepithelial potential.

21. The apparatus of claim 1, wherein the predefined geometric pattern is configured to modulate red blood cell zeta potential.

22. The apparatus of claim 1, wherein the apparatus is associated with reduction of at least one of the cardinal signs of inflammation: pain, swelling, heat and erythema.

23. The apparatus of claim 1, wherein the apparatus is incorporated into a brace, orthotic, compressive garment or clothing.

24. The apparatus of claim 23, wherein the compressive garment comprises a stocking, sleeve, shirt, brassiere, or wrap.

25. The apparatus of claim 1, wherein the apparatus is incorporated into headwear.

26. The apparatus of claim 1, wherein the apparatus comprises a plurality of stacked apparatus elements.

27. The apparatus of claim 1, wherein the curvilinear structures define rotational symmetry.

28. The apparatus of claim 27, wherein the rotational symmetry comprises approximately 180-degree rotational symmetry.

29. The apparatus of claim 1, wherein the substrate includes a central aperture.

30. The apparatus of claim 1, wherein the predefined geometric pattern comprises conductive structures disposed on the substrate.

31. The apparatus of claim 1, wherein the predefined geometric pattern is configured to interact with a local bioelectrical environment of tissue.

32. The apparatus of claim 1, wherein the predefined geometric pattern comprises non-intersecting curvilinear structures extending continuously across a substantial portion of the substrate.

33. The apparatus of claim 1, wherein the predefined geometric pattern provides a distributed geometric interaction with biological tissue rather than discrete point stimulation.

34. A method for modulating a physiological response in a subject, comprising:
positioning an apparatus adjacent to or in contact with a target anatomical region of the subject,
the apparatus including a substrate supporting a predefined radial arrangement of continuous non-intersecting curvilinear structures,
wherein placement of the apparatus adjacent to the target anatomical region produces a change in at least one electrophysiological parameter associated with inflamed tissue.

35. The method of claim 34, wherein the electrophysiological parameter comprises transepithelial potential.

36. The method of claim 34, wherein the electrophysiological parameter comprises red blood cell zeta potential.

37. The method of claim 34, wherein the apparatus is applied without active electrical stimulation.

38. A physiological modulation system comprising:
at least one wearable support structure configured to be worn on a body of a user; and
a plurality of apparatus elements coupled to the wearable support structure, each apparatus element comprising:
(a) a substrate; and
(b) a predefined geometric pattern comprising a plurality of non-intersecting curvilinear structures arranged in a radial configuration,
wherein the plurality of apparatus elements is spatially distributed relative to anatomical locations associated with pain, inflammation, swelling, or tissue dysfunction.

39. The physiological modulation system of claim 38, wherein the wearable support structure comprises kinesiology tape, a wound dressing, a brace, clothing, or a compression garment.

40. A surface structure configured for interaction with biological tissue, comprising: a plurality of continuous non-intersecting curvilinear structures arranged in a radial configuration extending from a central region toward an outer region, wherein:
(a) the curvilinear structures are organized into a plurality of sets;
(b) spacing between adjacent sets differs from spacing between adjacent curvilinear structures within a set; and
(c) the arrangement defines a distributed non-planar geometric interface configured to influence electrophysiological conditions associated with inflamed tissue.

41. A method of manufacturing a physiological modulation apparatus, comprising: forming a predefined pattern on a substrate, the predefined pattern comprising a plurality of continuous curvilinear structures extending from a central region toward an outer region.

42. The manufacturing method of claim 41, wherein the predefined pattern is formed by etching, molding, embossing, additive manufacturing or holographic pattern formation.
